(19) United States
(12) Patent Application Publication
(10) Pub. No.: US 2026/0011284 A1
(43) Pub. Date: Jan. 8, 2026

(54) ELECTRONIC DEVICE FOR CONTROLLING LUMINANCE OF DISPLAY, AND OPERATING METHOD AND RECORDING MEDIUM THEREOF

(71) Applicant: Samsung Electronics Co., Ltd., Suwon-si (KR)

(72) Inventors: Ganghyun GOO, Suwon-si (KR); Yongwoon KIM, Suwon-si (KR); Sangheon PARK, Suwon-si (KR); Kyungwon BAN, Suwon-si (KR); Suho JIN, Suwon-si (KR)

(21) Appl. No.: 19/255,269

(22) Filed: Jun. 30, 2025

Related U.S. Application Data
(63) Continuation of application No. PCT/KR2025/008709, filed on Jun. 23, 2025.

(30) Foreign Application Priority Data
Jul. 3, 2024 (KR) 10-2024-0087330
Oct. 28, 2024 (KR) 10-2024-0148825

(51) Int. Cl. G09G 3/20; G09G 3/3225

(52) U.S. Cl. CPC G09G 3/2096; G09G 3/3225; G09G 2310/066; G09G 2320/0653; G09G 2320/0693; G09G 2330/045

(57) ABSTRACT

An electronic device may include at least one sensor configured to output information associated with a temperature of the electronic device. The electronic device may include a display; at least one processor including a processing circuit; memory configured to store instructions. The instructions may, when executed by the at least one processor individually or collectively, based on a brightness level of the display being set to be a first level based on an ambient light level and based on a temperature of the electronic device determined using the at least one sensor reaching a first temperature, cause the electronic device to identify a temperature change rate within a designated time period and determine an intermediate temperature between the first temperature and a second temperature higher than the first temperature, the first temperature being set to reduce a brightness level of the display to an intermediate brightness level between the first level and a second level less than the first level, based on the identified temperature change rate. Based on the temperature change rate being greater than a threshold temperature change rate, the intermediate temperature may be set to a first value, and based on the temperature change rate being less than the threshold temperature change rate, the intermediate temperature may be set to a second value greater than the first value. The instructions may, when executed by the at least one processor individually or collectively, based on the current temperature of the electronic device reaching the intermediate temperature, cause the electronic device to reduce the brightness level of the display to the intermediate brightness level. The instructions may, when executed by the at least one processor individually or collectively, based on the current temperature reaching the second temperature, cause the electronic device to reduce the brightness level of the display to the second brightness level.

### CROSS-REFERENCE TO RELATED APPLICATIONS

This application is a continuation of International Application No. PCT/KR2025/008709 designating the United States, filed on Jun. 23, 2025, in the Korean Intellectual Property Receiving Office and claiming priority to Korean Patent Application Nos. 10-2024-0087330, filed on Jul. 3, 2024, and 10-2024-0148825, filed on Oct. 28, 2024, in the Korean Intellectual Property Office, the disclosures of each of which are incorporated by reference herein in their entireties.

### BACKGROUND

### Field

The disclosure relates to an electronic device, an operating method thereof, and a recoding medium for controlling a luminance (brightness) of a display.

### Description of Related Art

Remarkable developments in information communication and semiconductor technologies have allowed for the rapid spread and use of various electronic devices. Recent electronic devices have been developed to perform communication while being carried by a user. The electronic device may refer to a device performing a particular function according to an equipped program thereof, such as a mobile communication terminal, a tablet PC, a video/sound device, a desktop PC or laptop computer, a navigation for automobile, and the like.

The electronic device may provide various services through a display. The display may control the brightness of the display to a maximum level depending on the use environment. As the brightness of the display is maintained at the maximum level, heat may be generated in the display.

The above-described information may be provided as a related art to help understanding of the disclosure. No assertion or determination is made as to the applicability of any of the foregoing as prior art to the disclosure.

### SUMMARY

An electronic device according to an example embodiment may include: at least one sensor configured to output information associated with a temperature of the electronic device; a display; at least one processor including processing circuitry; and memory configured to store instructions, wherein the instructions, when executed by the at least one processor individually or collectively may cause the electronic device to, based on a brightness level of the display being set to be a first level based on an ambient light level and based on a temperature of the electronic device determined using the at least one sensor reaching a first temperature, identify a temperature change rate within a designated time period and determine an intermediate temperature between the first temperature and a second temperature higher than the first temperature, to reduce a brightness level of the display to an intermediate brightness level between the first level and a second level less than the first level, based on the identified temperature change rate; based on the temperature change rate being greater than a threshold temperature change rate, the intermediate temperature may be set to a first value, and based on the temperature change rate being less than the threshold temperature change rate, the intermediate temperature may be set to a second value greater than the first value; based on the current temperature of the electronic device reaching the intermediate temperature, reduce the brightness level of the display to the intermediate brightness level; and based on the current temperature reaching the second temperature, reduce the brightness level of the display to the second brightness level.

A method of operating an electronic device according to an example embodiment may include: based on a brightness level of a display of the electronic device being set to be a first level based on an ambient light level and based on a temperature of the electronic device identified using at least one sensor of the electronic device reaching a first temperature, identifying a temperature change rate within a designated time period and determining an intermediate temperature between the first temperature and a second temperature higher than the first temperature, to reduce a brightness level of the display to an intermediate brightness level between the first level and a second level less than the first level, based on the identified temperature change rate; based on the temperature change rate being greater than a threshold temperature change rate, the intermediate temperature may be set to a first value, and based on the temperature change rate being less than the threshold temperature change rate, the intermediate temperature may be set to a second value greater than the first value; based on the current temperature of the electronic device reaching the intermediate temperature, reducing the brightness level of the display to the intermediate brightness level; and based on the current temperature reaching the second temperature, reducing the brightness level of the display to the second level.

A non-transitory computer-readable storage medium according to an example embodiment may be configured to store computer-executable instructions, wherein the computer-executable instructions, when executed by at least one processor including processing circuitry individually or collectively may cause an electronic device to: based on a brightness level of a display of an electronic device being set to be a first level based on an ambient light level and based on a temperature of the electronic device identified using at least one sensor of the electronic device reaching a first temperature, identify a temperature change rate within a designated time period and determine an intermediate temperature between the first temperature and a second temperature higher than the first temperature, to reduce a brightness level of the display to an intermediate brightness between the first level and a second level less than the first level, based on the identified temperature change rate; based on the temperature change rate being greater than a threshold temperature change rate, the intermediate temperature may be set to a first value; based on the temperature change rate being less than the threshold temperature change rate, the intermediate temperature may be set to a second value greater than the first value; based on the current temperature of the electronic device reaching the intermediate temperature, reduce the brightness level of the display to the intermediate brightness level; and based on the current temperature reaching the second temperature, reduce the brightness level of the display to the second level.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an electronic device according to various embodiments;

FIG. 3A is a diagram illustrating an example of changing a brightness level of a display according to various embodiments;

FIG. 3B is a diagram illustrating an example method for changing a brightness level of a display according to various embodiments;

FIG. 3C is a diagram illustrating an example of power consumed depending on brightness of a screen provided through a display according to various embodiments;

FIG. 4 is a diagram illustrating at least one sensor disposed within an electronic device according to various embodiments;

FIG. 5 is a flowchart illustrating an example method for controlling a brightness level of a display of an electronic device according to various embodiments;

FIG. 6A is a diagram illustrating an example method for changing a brightness level of a display of an electronic device according to various embodiments;

FIG. 6B is a diagram illustrating an example current consumed depending on a brightness level of a display according to various embodiments;

FIG. 6C is a graph illustrating a time period during which an electronic device may operate at a high brightness depending on a brightness level of a display according to various embodiments;

FIG. 7A is a graph illustrating an example of a temperature change rate of an electronic device according to various embodiments;

FIG. 7B is a graph illustrating an example of reducing a brightness level of a display of an electronic device according to various embodiments;

FIG. 8 is a graph illustrating an example operation of reducing a brightness level of a display of an electronic device to an intermediate brightness level according to various embodiments;

FIG. 9 is a flowchart illustrating an example method for controlling a brightness level of a display of an electronic device according to various embodiments;

FIG. 10 is a flowchart illustrating an example method for controlling a brightness level of a display of an electronic device according to various embodiments;

FIG. 11 is a graph illustrating an example method for controlling a brightness level of a display of an electronic device according to various embodiments;

FIG. 12 is a flowchart illustrating an example method for controlling a brightness level of a display of an electronic device according to various embodiments;

FIG. 13 is a graph illustrating an example method for controlling a brightness level of a display of an electronic device according to various embodiments;

FIG. 14 is a flowchart illustrating an example method for controlling a brightness level of a display of an electronic device according to various embodiments;

FIG. 15 is a flowchart illustrating an example method for controlling a brightness level of a display of an electronic device according to various embodiments;

FIG. 16 is a graph illustrating an example method for controlling a brightness level of a display of an electronic device according to various embodiments;

FIG. 17A is a flowchart illustrating an example method for determining an intermediate temperature for controlling a brightness level of a display of an electronic device according to various embodiments;

FIG. 17B is a diagram illustrating an example method for identifying a grip event of an electronic device according to various embodiments;

FIG. 18A is a flowchart illustrating an example method for determining an intermediate temperature for controlling a brightness level of a display of an electronic device according to various embodiments;

FIG. 18B is a graph illustrating a current consumption according to an operation of an electronic device according to various embodiments;

FIG. 19 is a flowchart illustrating an example method for setting a threshold temperature for controlling a brightness level of a display of an electronic device according to various embodiments;

FIG. 20 is a flowchart illustrating an example method for controlling a brightness level of a display of an electronic device according to various embodiments; and

FIG. 21 is a diagram illustrating an example method for controlling a brightness level of a display of an electronic device according to various embodiments.

### DETAILED DESCRIPTION

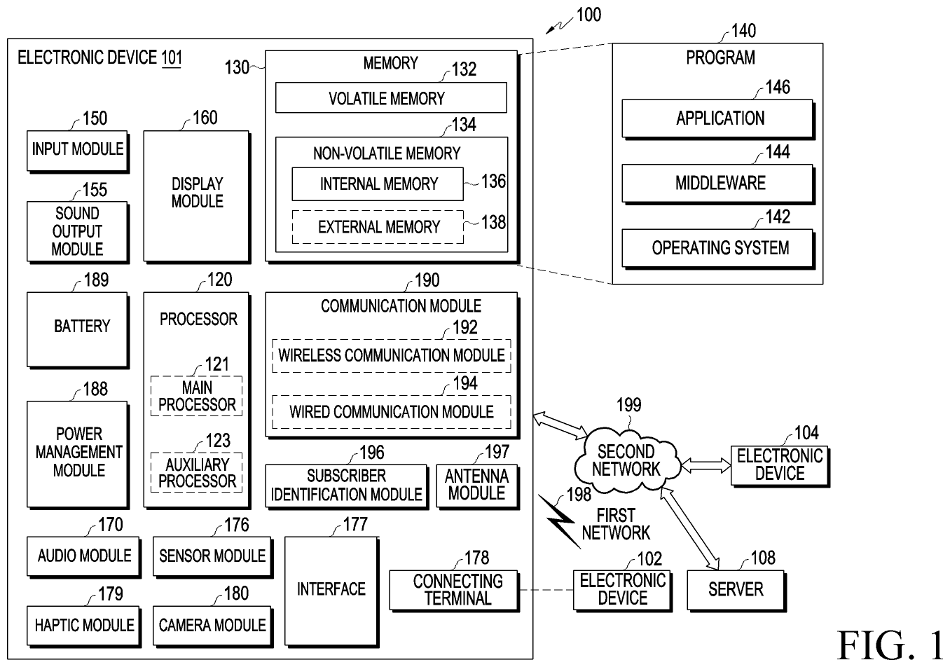

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™M, wireless-fidelity (Wi-Fi) direct, or infrared data association (IrDA)) or the second network 199 (e.g., a long-range communication network, such as a legacy cellular network, a 5 G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5 G network, after a 4 G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5 G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

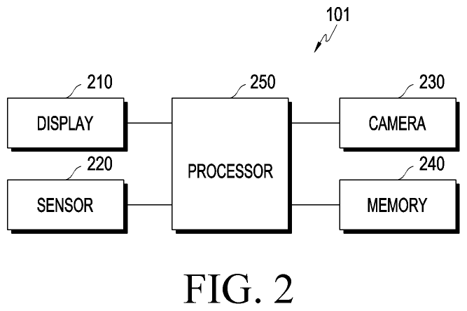

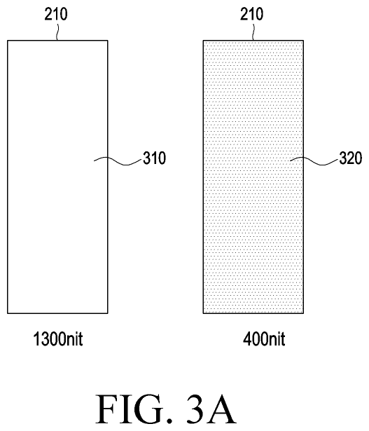

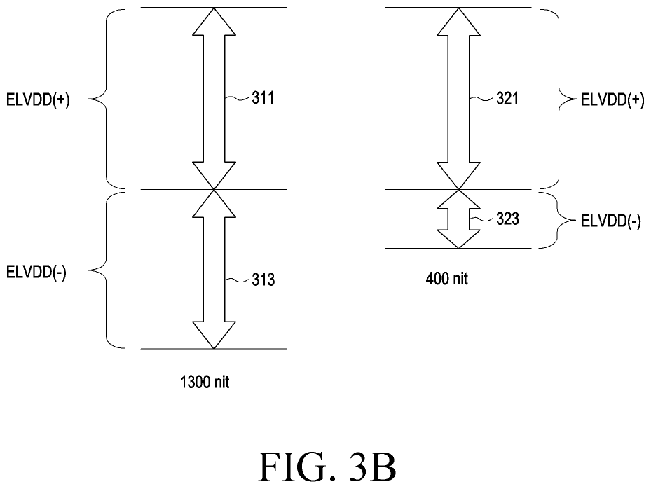

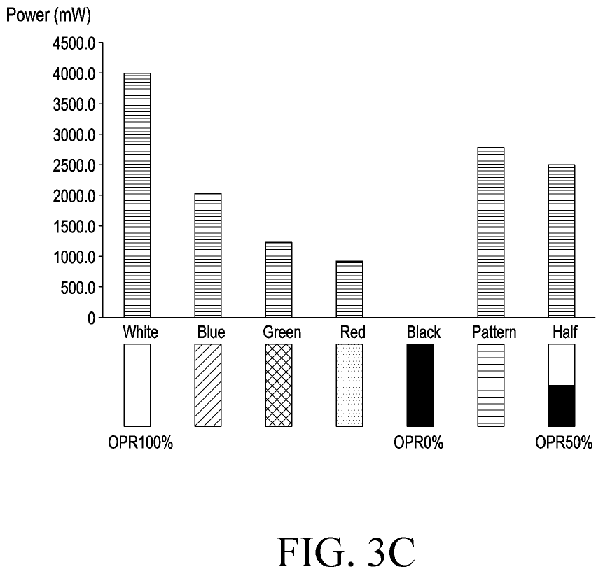

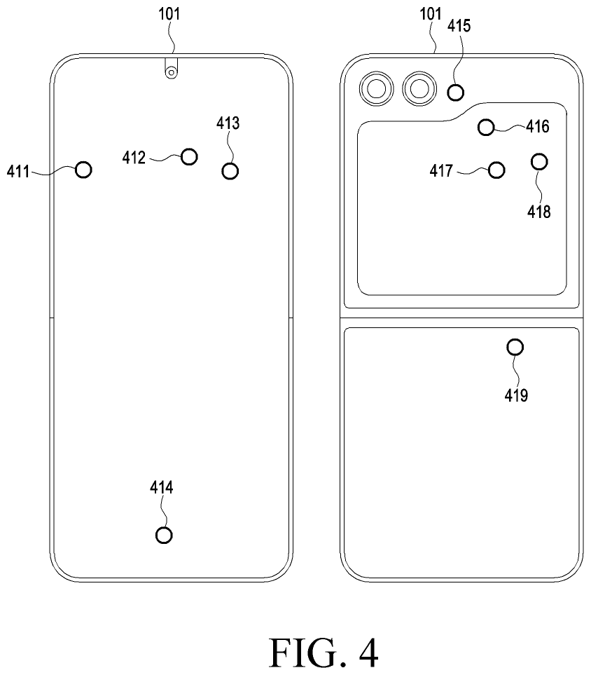

FIG. 2 is a block diagram illustrating an example configuration of an electronic device according to various embodiments. FIG. 2 will be described with reference to FIGS. 3A, 3B, 3C, and 4. FIG. 3A is a diagram illustrating an example of changing a brightness level of a display according to various embodiments. FIG. 3B is a diagram illustrating a method for changing a brightness level of a display according to various embodiments. FIG. 3C is a diagram illustrating an example of power consumed depending on brightness of a screen provided through a display according to various embodiments. FIG. 4 is a diagram illustrating at least one sensor disposed within an electronic device according to various embodiments.

In an embodiment, the electronic device 101 may correspond to the electronic device 101 in FIG. 1.

Referring to FIG. 2, in an embodiment, the electronic device 101 may include a display 210, at least one sensor 220, a camera 230, memory 240, and/or a processor (e.g., including processing circuitry) 250.

In an embodiment, the display 210 may be included in the display module 160 in FIG. 1. A screen having a brightness level set by the processor 250 may be provided through the display 210. For example, in an environment where direct sunlight enters the electronic device 101 outdoors, a brightness level of the display 210 may be set to be a set maximum brightness level (e.g., 1300 nits). Referring to FIG. 3A, the brightness level of the display 210 may be set to be a high brightness level (e.g., 1300 nits) or a low brightness level (e.g., 400 nits). The brightness level of the display 210 may include various brightness levels in addition to the example of FIG. 3A, and an example wherein the brightness level of the display 210 is controlled to an intermediate brightness level between 1300 nits and 400 nits will be described in greater detail below. The term “nit” may refer, for example, to to a light intensity of 1 cd per square meter. In an embodiment, in case that a screen 310 having a brightness level of 1300 nits is continuously displayed through the display 10, the current consumed may increase. In case that a screen 320 having a brightness level of 400 nits is displayed through the display 210, relatively less currents may be consumed compared to when the brightness level of the display is set to 1300 nits. Referring to FIG. 3B, in an embodiment, the brightness of the display 210 (or panel) may be determined by a power supply and/or a design of the panel. The display 210 may include an active-matrix organic light emitting diode (AMOLED) circuit. The brightness of the panel may be determined, for example, by a difference between a potential of an ELVDD(+) signal and a potential of an ELVDD(−) signal. The ELVDD(+) signal may be provided to the display 210, based on a value set in response to a type of the panel. The potential of the ELVDD(+) signal may not depend on the brightness of the display 210 while the display 210 is driven. For example, a voltage size 311 corresponding to the ELVDD(+) signal for a brightness level of 1300 nits may be identical to a voltage size 321 corresponding to the ELVDD(+) signal for a brightness level of 400 nits. The potential of the ELVDD(−) signal may have a negative value. As the potential of the ELVDD(−) signal is reduced, the brightness of the display 210 may increase. For example, a potential of the ELVDD(−) signal for the brightness level of 1300 nits may be less than a potential of the ELVDD(−) signal for the brightness level of 400 nits. A voltage size 313 (or absolute value) of the ELVDD(−) signal for the brightness level of 1300 nits may be greater than a voltage size 323 (or absolute value) of the ELVDD(−) signal for the brightness level of 400 nits. A difference between a potential of the ELVDD(+) signal and a potential of the ELVDD(−) signal for the brightness level of 1300 nits may be greater than a difference between a potential of the ELVDD(+) and a potential of the ELVDD(−) signal for the brightness level of 400 nits. A sum of a voltage size 311 corresponding to the ELVDD(+) signal and a voltage size 313 corresponding to the ELVDD(−) signal for the brightness level of 1300 nits may be greater than a sum of a voltage size 321 corresponding to the ELVDD(+) and a voltage size 323 corresponding to the ELVDD(−) signal for the bright level of 400 nits.

In an embodiment, the display 210 may correspond to an AMOLED display. Referring to FIG. 3C, in an embodiment, significant power may be required to drive the display 210 at an on pixel ratio (OPR) condition of 100% (or, full white). In case that the display 210 is driven at the set maximum brightness level (e.g., 1300 nits) in an outdoor direct sunlight condition, heat may be generated in the display 210. A surface temperature of the electronic device 101 may be continuously increased due to the heat of the display 210. The electronic device 101 may perform heat control, based on the surface temperature reaching a set threshold value. For example, the electronic device 101 may control the brightness level of the display 210 below a set minimum value.

In an embodiment, the display 210 may be a foldable display including a plurality of areas separated by at least one folding line.

In an embodiment, the at least one sensor 220 may be included in the sensor module 176 in FIG. 1.

In an embodiment, the at least one sensor 220 may include at least one thermistor. The at least one thermistor may be disposed in the electronic device 101. The at least one thermistor may be configured to output information associated with a temperature of the electronic device 101. Referring to FIG. 4, in order to monitor the temperature of the electronic device 101, a plurality of thermistors 411, 412, 413, 414, 415, 416, 417, 418, and 419 may be disposed in the electronic device 101 (or the housing). For stable operation, the electronic device 101 may identify a temperature of at least one component disposed in the electronic device 101 using each of the plurality of thermistors 411, 412, 413, 414, 415, 416, 417, 418, and 419. Each of the plurality of thermistors 411, 412, 413, 414, 415, 416, 417, 418, and 419 may be implemented as at least a portion of each of a plurality of components disposed in the electronic device 101. Each of the plurality of thermistors 411, 412, 413, 414, 415, 416, 417, 418, and 419 may be disposed at positions adjacent to each of a plurality of components disposed in the electronic device 101. The electronic device 101 may control an operation corresponding to at least one component, based on the identified temperature of the at least one component. In an embodiment, the electronic device 101 may identify a temperature of the electronic device 101 using the plurality of thermistors 411, 412, 413, 414, 415, 416, 417, 418, and 419. The electronic device 101 may identify (or estimate) a current surface temperature of the electronic device 101, based on a value acquired from at least a portion of the plurality of thermistors 411, 412, 413, 414, 415, 416, 417, 418, and 419. For example, the electronic device 101 may calculate a surface heat generation temperature, based on matching (or combining) a pre-measured temperature of a thermistor with a current heat measurement result for each use case.

In an embodiment, the at least one sensor 220 may include an illuminance sensor. The at least one sensor 220 may include a grip sensor.

In an embodiment, the camera 230 may be included in the camera module 180 in FIG. 1. In an embodiment, the camera 230 may acquire images of objects outside the electronic device 101. The camera 230 may include, for example, a front camera.

In an embodiment, the memory 240 may be included in the memory 130 in FIG. 1. The memory 240 may store instructions. The instructions may, when executed by the at least one processor 250 individually or collectively, cause the electronic device 101 to perform various operations.

In an embodiment, the processor 250 may be included in the processor 120 in FIG. 1, and the description of the processor 120 above applies equally to the processor 250.

In an embodiment, the processor 250 may include various processing circuitry and control overall operations for controlling a brightness level of the display 210. The processor 250 may include one or more processors to perform an operation of controlling a brightness level of the display 210. For example, the processor 250 may correspond to a plurality of processors which divide a plurality of operations to processors and collectively perform the operations. The memory 250 may include a processing circuit (not shown). The operations performed by the processor 250 will be described below.

In an embodiment, the processor 250 may include a neural processing unit (NPU) configured to control a brightness level of the display 210. For example, in case that an operation of controlling a brightness level of the display 210 is performed using a designated algorithm, the processor 250 may include a graphics processing unit (GPU) configured to perform the operation of controlling the brightness level of the display 210 using the designated algorithm.

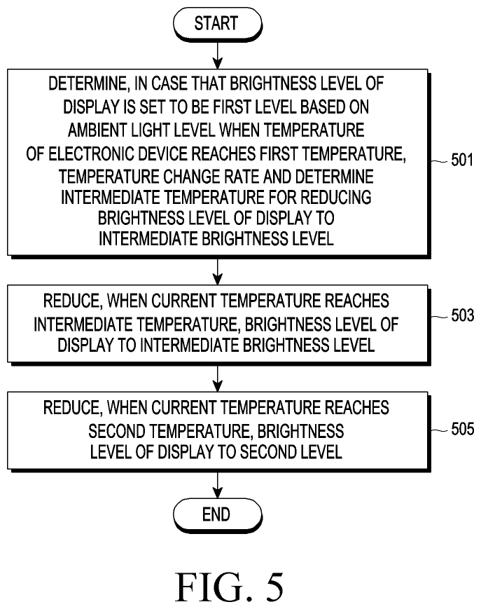

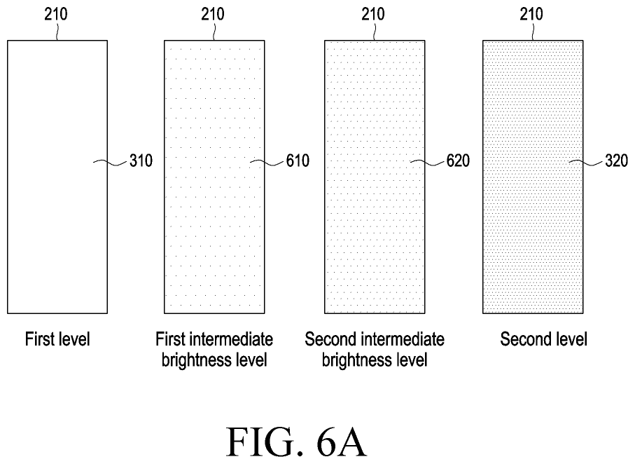

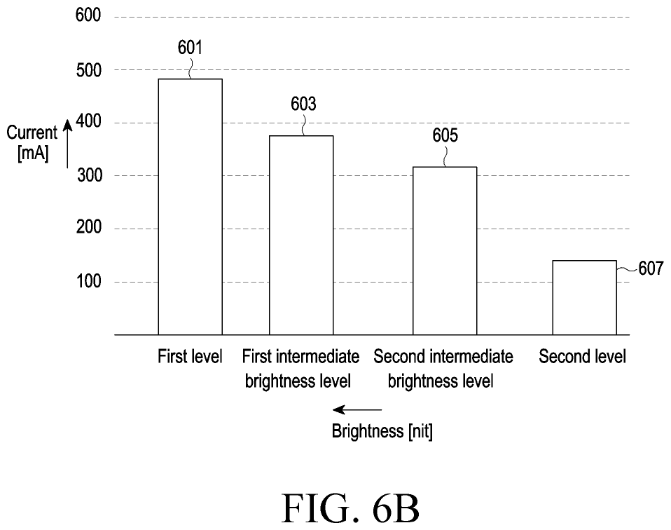

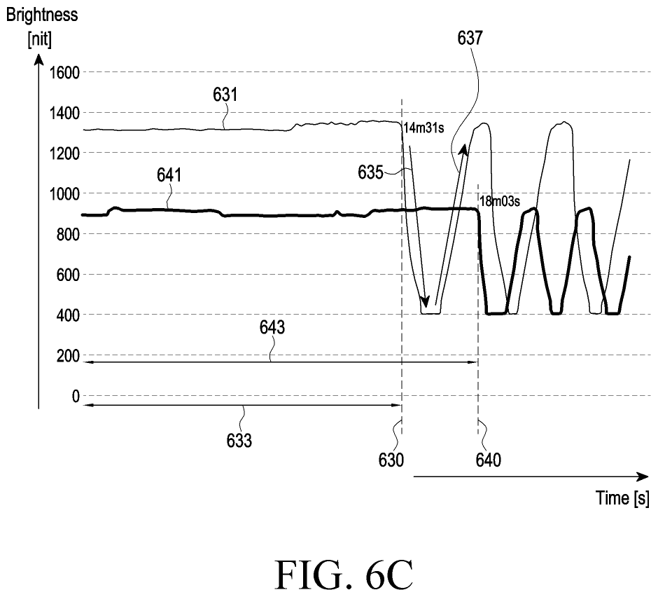

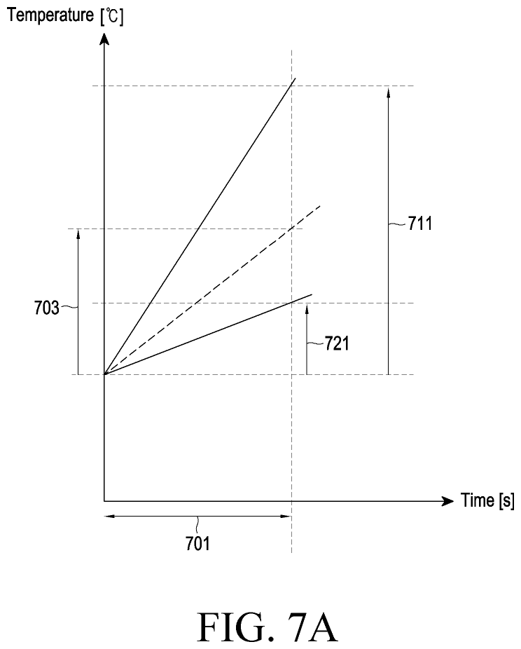

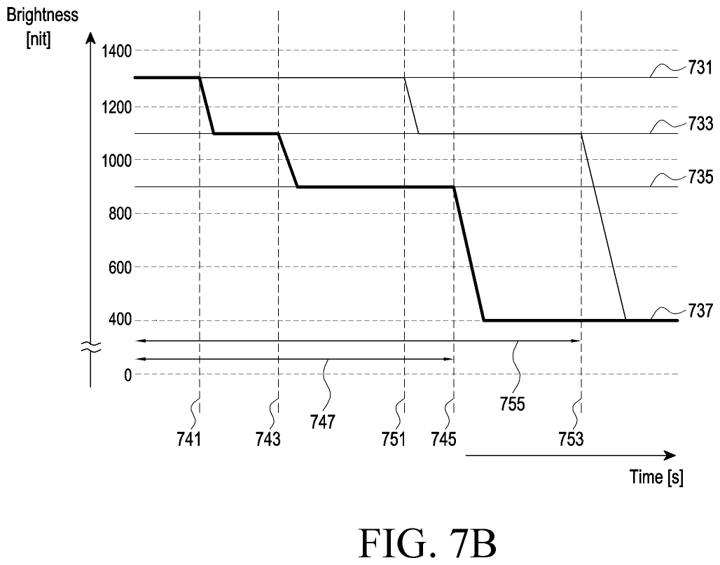

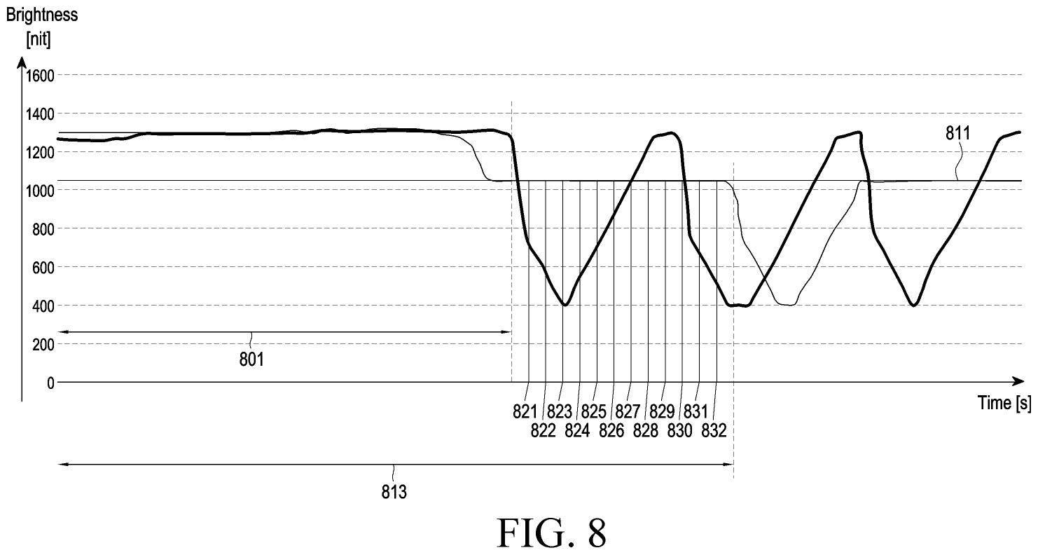

FIG. 5 is a flowchart illustrating an example method for controlling a brightness level of a display of an electronic device according to various embodiments. FIG. 5 will be described with reference to FIGS. 6A, 6B, 6C, 7A, 7B, and 8. FIG. 6A is a diagram illustrating an example method for changing a brightness level of a display of an electronic device according to various embodiments. FIG. 6B is a graph illustrating an example current consumed depending on a brightness level of a display according to various embodiments. FIG. 6C is a graph illustrating a time period during which an electronic device may operate at a high brightness depending on a brightness level of a display according to various embodiments. FIG. 7A is a graph illustrating an example of a temperature change rate of an electronic device according to various embodiments. FIG. 7B is a graph illustrating an example of reducing a brightness level of a display of an electronic device according to various embodiments. FIG. 8 is a graph illustrating an example operation of reducing a brightness level of a display of an electronic device to an intermediate brightness level according to various embodiments.

Referring to FIG. 5, in operation 501, the electronic device 101 (e.g., the processor 250 in FIG. 2) may, in case that a brightness level of the display (e.g., the display 210 in FIG. 2) is set to a first level based on an ambient light level, when a temperature of the electronic device 101 identified using at least one sensor (e.g., the at least one sensor 220 in FIG. 2) reaches a first temperature, identify a temperature change rate within a specified time interval and determine an intermediate temperature set to reduce the brightness level of the display to an intermediate brightness level between the first level and a second level less than the first level, based on the identified temperature change rate. The intermediate temperature may correspond to a temperature between the first temperature and a second temperature higher than the first temperature. If the temperature change rate is greater than a threshold temperature change rate, the intermediate temperature may be set to a first value. If the temperature change rate is less than the threshold temperature change rate, the intermediate temperature may be set to a second value greater than the first value.

In an embodiment, the electronic device 101 may control the brightness level to be the first level. Referring to FIG. 6A, in an embodiment, the display 210 may be controlled to be a first level, a first intermediate brightness level, a second intermediate brightness level, or a second level. The first level may be a set maximum brightness level of the display 210 under an outdoor natural light condition. In case that the screen 310 having a brightness level corresponding to the first level is continuously displayed, heat may be generated in the display 210. The first level may be, for example, 1300 nits, but there is no limitation. The electronic device 101 may control the brightness of the display 210 to the first level, based on a condition for operating in a high brightness mode being satisfied. The high brightness mode may be setting for controlling the brightness level of the display 210 to a set maximum brightness level (or brightness greater than 500 nits) in the outdoor light condition. The condition for operating in the high brightness mode will be described below.

In an embodiment, the electronic device 101 may perform heat generation control for a light span of the electronic device 101 and performance of a battery (e.g., the battery 189 in FIG. 1). For example, the electronic device 101 may, based on measuring the temperature of the electronic device 101, change an operation frequency of the processor (e.g., an application processor) by referencing a clock in Table 1.

TABLE 1

| | Set | | | Brightness |
|---|---|---|---|---|
| | temperature | AP (application processor) | | control |
| Mode | [° C.] | CPU | GPU | [nit] |
| First mode | 36 | First clock control | | — |
| | 37 | | | |
| | 38 | | | |
| Second mode | 39 | Second clock control | | |
| | 40 | | | 400 |
| Third mode | 41 | Third clock control | | 300 |
| | 42 | | | |
| | 43 | | | |
| Fourth mode | 44 | Fourth clock control | | |
| | 45 | | | |
| | 46 | | | |
| | 47 | | | |

For example, the electronic device 101 may operate in the first mode (e.g., a light mode) at a temperature range between 36 degrees and 38 degrees. The electronic device 101 may control an AP frequency, based on the first clock control in the first mode. The electronic device 101 may not perform brightness control (or brightness change for heat generation control) in the first mode. The electronic device 101 may operate in the second mode (e.g., a moderate mode) at a temperature range between 39 degrees and 40 degrees. The electronic device 101 may operate based on the second clock control in the second mode. The electronic device 101 may reduce the brightness of the display to 400 nits, based on the temperature of the electronic device 101 reaching a temperature of 40 degrees. In case that the electronic device 101 immediately reduces the brightness of the display to 400 nits, the brightness of the screen displayed through the display may decrease dramatically. The electronic device 101 may operate in the third mode (e.g., a severe mode) at a temperature range between 41 degrees and 43 degrees. The electronic device 101 may operate based on the third clock control in the third mode. The electronic device 101 may operate in the fourth mode (e.g., a critical mode) at a temperature range between 44 degrees and 47 degrees. The electronic device 101 may operate based on the fourth clock control in the fourth mode. The electronic device 101 may reduce the brightness of the display to 300 nits, based on the temperature of the electronic device 101 reaching a temperature of 41 degrees.

Referring to FIG. 6A again, the brightness of the screen 610 having the brightness level corresponding to the first intermediate brightness level may be less than that of the screen 310 having the brightness level corresponding to the first level. The first intermediate brightness level may be 1100 nits, but there is no limitation. The brightness of the screen 620 having the brightness level corresponding to the second intermediate brightness level may be less than that of the screen 610 having the brightness level corresponding to the first intermediate brightness level. The second intermediate brightness level may be 900 nits, but there is no limitation. The brightness of the screen 320 having the brightness level corresponding to the second level may be less than that of the screen 620 having the brightness level corresponding to the second intermediate brightness level. The second level may be 400 nits, but there is no limitation. Referring to FIG. 6B, in an embodiment, the current consumption of a display corresponding to brightness may increase as the brightness increases. The current consumption amount 603 in case that the display is controlled to the first intermediate brightness level may be less than the current consumption amount 601 in case that the display is controlled to the first level. The current consumption amount 605 in case that the display is controlled to the second intermediate brightness level may be less than the current consumption amount 603 in case that the display is controlled to the first intermediate brightness level. The current consumption amount 607 in case that the display is controlled to the second level may be less than the current consumption amount 605 in case that the display is controlled to the second intermediate brightness level. In case that the display operates at the first level, a high voltage and a high current amount 601 may be required. In case that the display operates at the first level for a long time period, heat may be generated in the display. Instead of reducing the brightness level of the display directly from the first level to the second level, the electronic device 101 may reduce the brightness level of the display to at least one intermediate brightness from the first level to ensure visibility. For example, based on the heat generated in the display (or the electronic device 101), the electronic device 101 may reduce the brightness level of the display from the first level to the first intermediate brightness level. The electronic device 101 may reduce the brightness level of the display from the first level to the second intermediate brightness level. In case that the temperature of the electronic device 101 is continuously increasing as a result of the display being continuously controlled to at least one intermediate brightness level, the electronic device 101 may reduce the brightness level of the display to the second level.

In an embodiment, a current consumption amount in case that the display is controlled to the intermediate brightness level may be less than a current consumption amount in case that the display is controlled to the first level. The electronic device 101 may control the brightness level of the display to the intermediate brightness level, so as to display a screen having a high brightness level for a long time period. Referring to FIG. 6C, in an embodiment, the electronic device 101 may control the brightness level of the display to 1300 nits (631). In case that the display is driven at 1300 nits for a long time period, the temperature of the electronic device 101 may increase. The electronic device 101 may abruptly reduce the brightness level of the display to 400 nits (635) at a time point 630 when the temperature of the electronic device 101 reaches a threshold temperature for performing heat control. The electronic device 101 may abruptly increase the brightness level of the display to 1300 nits (637) at a time point when the temperature of the electronic device 101 is reduced less than the threshold temperature for performing heat control. In an embodiment, the electronic device 101 may control the brightness level of the display to 900 nits (641). In case that the display is driven at 900 nits for a long time period, the temperature of the electronic device 101 may increase. The electronic device 101 may reduce the brightness level of the display to 400 nits at a time point 640 when the temperature of the electronic device 101 reaches the threshold temperature for performing heat control.

In case that the display is controlled at a low brightness, it is possible to delay the time to enter heat control. A time period 643 required to enter heat control in case that the brightness of the display is controlled to 900 nits may be longer than a time period 633 to enter heat control in case that the brightness of the display is controlled to 1300 nits.

In an embodiment, in case that the temperature of the electronic device 101 reaches the first temperature, the electronic device 101 may determine an intermediate temperature set to reduce the brightness level of the display to an intermediate brightness between a first brightness and a second brightness less than the first brightness. As described with reference to FIGS. 6A, 6B, and 6C, the electronic device 101 may, based on the time period required to enter heat control (or until the temperature of the electronic device reaches a temperature that indicates the electronic device is in a heat generation state) being relatively long when the display is controlled at a medium brightness, decrease the brightness level of the display from the first level to the intermediate brightness level instead of reducing the brightness level of the display directly from the first level to the second level to ensure visibility in an outdoor light condition. Based on the temperature of the electronic device 101 reaching the first temperature, the electronic device 101 may determine an intermediate temperature set to reduce the brightness level of the display to the intermediate brightness level. For example, the electronic device 101 may, in case that the temperature change rate of the electronic device 101 is low, reduce the brightness level of the display from a third temperature between the first temperature and the second temperature. The first temperature, the second temperature, or the third temperature may be replaced with terms such as a first threshold temperature, a second threshold temperature, or a third threshold temperature.

In an embodiment, the electronic device 101 may identify a temperature change rate within a designated time period and determine the intermediate temperature set to reduce the brightness of the display to the intermediate brightness, based on the identified temperature change rate. The temperature change rate may represent the amount of change in temperature over a set time period. Referring to FIG. 7A, the electronic device 101 may identify the temperature change rate of the electronic device 101 for a set time period 701. While the electronic device 101 controls the brightness level of the display to the maximum brightness level set for the outdoor light environment, the temperature change rate of the electronic device 101 may vary depending on operation conditions of the electronic device 101. For example, in case that the electronic device 101 performs an operation requiring high power, the temperature change rate 711 of the electronic device 101 may be greater than a threshold temperature change rate 703. In case that the electronic device 101 performs an operation requiring low power, the temperature change rate 721 of the electronic device 101 may be less than the threshold temperature change rate 703. If the temperature change rate is greater than the threshold temperature change rate, the intermediate temperature may be determined to have the first value. The first value may be, but is not limited to, the first temperature. If the temperature change rate is less than the threshold temperature change rate, the intermediate temperature set to reduce the brightness level of the display to the intermediate brightness may be set to a second value greater than the first value. The second value may be, but is not limited to, the third temperature, for example.

Referring back to FIG. 5, in operation 503, according to an embodiment, the electronic device 101 may, when the current temperature of the electronic device 101 reaches the intermediate temperature, reduce the brightness level of the display to the intermediate brightness level.

Referring to FIG. 7B, in an embodiment, the electronic device 101 may start brightness control at an early time point, based on the temperature change rate of the electronic device 101 being greater than the threshold temperature change rate. For example, the electronic device 101 may reduce the brightness level of the display from 1300 nits to 1100 nits after a time point 741 when the electronic device 101 reaches the first temperature (or at a time point when the first temperature is reached). The electronic device 101 may reduce the brightness level of the display to the first intermediate brightness level 733 less than the first level 731, based on the temperature change rate being greater than the threshold temperature change rate. The temperature change rate may correspond to a temperature change rate measured after the temperature of the electronic device 101 reaches the first temperature. The temperature change rate may correspond to a temperature change rate measured immediately before the temperature of the electronic device 101 reaches the first temperature. The temperature change rate may correspond to a temperature change rate measured immediately when the temperature of the electronic device 101 is less than the first temperature. In an embodiment, the electronic device 101 may determine a policy for reducing the brightness level of the display using the temperature change rate identified based on the temperature of the electronic device 101 reaching the first temperature. In an embodiment, the electronic device 101 may determine a policy for reducing the brightness level of the display using one or more temperature change rates periodically identified while the temperature of the electronic device 101 increases sequentially after the temperature of the electronic device 101 reaches the first temperature. The electronic device 101 may reduce the brightness of the display to the second intermediate brightness level 735 at a time point 743 when the electronic device 101 reaches the third temperature based on the temperature change rate being greater than the threshold temperature change rate. The electronic device 101 may reduce the brightness level of the display to the second level 737 at a time point 745 when the electronic device 101 reaches the second temperature based on the temperature change rate being greater than the threshold temperature change rate.

Referring to FIG. 7B again, in an embodiment, the electronic device 101 may reduce the brightness level of the display to the first intermediate brightness level 733 when the temperature of the electronic device 101 reaches a third threshold temperature higher than the first temperature (751), based on the temperature change rate being less than the threshold temperature change rate. The electronic device 101 may reduce the brightness level of the display to the second level 737 at a time point 753 when the electronic device 101 reaches the second temperature, based on the temperature change rate being less than the threshold temperature change rate.

In an embodiment, a change pattern of the brightness level in case that the temperature change rate of the electronic device 101 is less than the threshold change rate may be different from a change pattern of the brightness level in case that the temperature change rate of the electronic device 101 is greater than the threshold change rate. For example, a time period 755 during which the electronic device 101 is operable at a high brightness level (e.g., the first level 731 and the first intermediate brightness level 733) in case that the temperature change rate of the electronic device 101 is less than the threshold change rate may be longer than a time period 747 during which the electronic device 101 is operable at a high brightness level (e.g., the first level 731, the first intermediate brightness level 733, and the second intermediate brightness level 755) in case that the temperature change rate of the electronic device 101 is greater than the threshold change rate. The electronic device 101 may achieve visibility in the high brightness mode based on reducing the brightness level of the display to an intermediate brightness level (e.g., the first intermediate brightness level 733 or the second intermediate brightness level 735) before the temperature of the electronic device 101 reaches the second temperature, thereby increasing the time period during which the electronic device 101 may operate at the high brightness level. The number of intermediate brightnesses to ensure visibility in the high brightness mode is not limited to the example in FIG. 7B. For example, the electronic device 101 may control the brightness level of the display such that the brightness of the display appears to change at a slow rate, based on sequentially reducing the brightness level of the display to three or more intermediate brightness levels between the first level 731 and the second level 737. Based on reducing the brightness level of the display to an intermediate brightness level, the electronic device 101 may reduce the potential for degradation of the user experience due to rapid changes in brightness.

Referring back to FIG. 5, in operation 505, according to an embodiment, the electronic device 101 may, when the current temperature of the electronic device 101 reaches the second temperature, reduce the brightness level of the display to the second level. The second level may be any brightness level set to control the heat generation of the electronic device 101 without limitation. Referring to FIG. 8, in an embodiment, the electronic device 101 may, based on the temperature of the electronic device 101 reaching the first temperature, reduce the brightness level of the display according to a plurality of time periods 813 such that the brightness level of the display is controlled to be identical during one or more adjacent time points 821, 822, 823, 824, 825, 826, 827, 828, 829, 830, 831, and 832 among the plurality of time periods 813. For example, the electronic device 101 may reduce the brightness level of the display to the intermediate brightness level 811, based on the temperature of the electronic device 101 reaching an intermediate temperature set to achieve the visibility at the high brightness mode. The electronic device 101 may control the brightness level of the display such that the brightness level of the display remains identical to the intermediate brightness level 811 during adjacent time points. The electronic device 101 may control the display to be driven at a high brightness level for a long time period 813, based on reducing the brightness level of the display to an intermediate brightness level as the temperature of the electronic device 101 increases. For example, a time period 801 during which operation at a high brightness level is possible in the case of continuing to operate at the set maximum brightness level without going through an intermediate brightness level may be shorter than a time interval 813 during which operation goes through the intermediate brightness level.

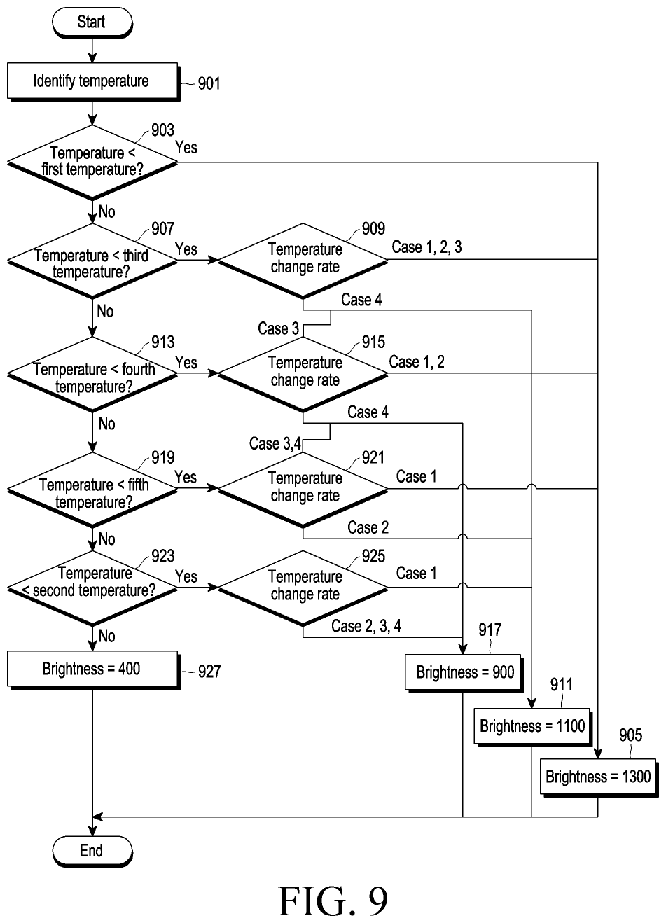

FIG. 9 is a flowchart illustrating an example method for controlling a brightness level of a display of an electronic device according to various embodiments.

Referring to FIG. 9, in operation 901, in an embodiment, the electronic device 101 (e.g., the processor 250 in FIG. 2) may identify the temperature of the electronic device 101.

In operation 903, in an embodiment, the electronic device 101 may identify whether the temperature is less than the first temperature. The first temperature may, for example, be 36 degrees, but there is no limitation. The electronic device 101 may, based on identifying the temperature less than the first temperature (operation 903-Yes), set the brightness of the display to 1300 nits, in operation 905.

In an embodiment, based on identifying the temperature equal to or greater than the first temperature (operation 903-No), in operation 907, the electronic device 101 may identify whether the temperature is less than the third temperature higher than the first temperature. The third temperature may, for example, be 37 degrees but there is no limitation. Based on identifying the temperature less than the third temperature (operation 907-Yes), the electronic device 101 may, in operation 909, identify a case corresponding to the temperature change rate of the electronic device 101. For example, the electronic device 101 may identify a case corresponding to the temperature change rate according to Table 2.

TABLE 2

| | Temperature | HBM brightness for each temperature | | | | | | |
|---|---|---|---|---|---|---|---|---|
| | change level | (OPR 100%) | | | | | | |
| Change | (For 20 seconds) | −35.9° C. | 36.0-36.9° C. | 37.0-37.9° C. | 38.0-38.9° C. | 39.0-39.9° C. | 40.0-40.9° C. | 41.0° C. |
| Case | Temperature ≤0.2° C. | 1300 | 1300 | 1300 | 1300 | 1100 | 400 | |
| 1 | | | | | | | | |
| Case | 0.2° C. < | 1300 | 1300 | 1300 | 1100 | 900 | | |
| 2 | temperature <0.6° C. | | | | | | | |
| Case | 0.6° C. ≤ | 1300 | 1300 | 1100 | 900 | 900 | | |
| 3 | temperature <1.0° C. | | | | | | | |
| Case | 1.0° C. ≤ | 1300 | 1100 | 900 | 900 | 900 | | |
| 4 | temperature | | | | | | | |

In an embodiment, the temperature change rate may be measured at a period of 20 seconds. In an embodiment, the electronic device 101 may identify a change policy of the brightness level, based on the temperature change rate being identified based on the temperature of the electronic device 101 reaching 36 degrees. The electronic device 101 may, for example, based on the temperature change rate being less than 1 degree (a first case, a second case, and a third case) at a temperature higher than 36 degrees and less than 37 degrees, set the brightness of the display to 1300 nits in operation 905. The electronic device 101 may, based on the temperature change rate exceeding 1 degree (a fourth case) in a temperature higher than 36 degrees and less than 37 degrees, set the brightness of the display to 1100 nits in operation 911. In an embodiment, the electronic device 101 may identify a change policy of the brightness level, based on one or more temperature change rates periodically identified while the temperature of the electronic device 101 increases.

In an embodiment, based on identifying the temperature equal to or greater than the third temperature (operation 907-No), the electronic device 101 may, in operation 913, identify whether the temperature is less than a fourth temperature higher than the third temperature. The fourth temperature may, for example, be 38 degrees but there is no limitation. Based on identifying the temperature less than the fourth temperature (operation 913-Yes), the electronic device 101 may, in operation 915, identify a case corresponding to the temperature change rate of the electronic device 101. The electronic device 101 may, for example, based on the temperature change rate being less than 0.6 degree (the first case and the second case) at a temperature higher than 37 degrees and less than 38 degrees, set the brightness level of the display to 1300 nits in operation 905. The electronic device 101 may, based on the temperature change rate being between 0.6 degrees and 1.0 degree (the third case) at a temperature higher than 37 degrees and less than 38 degrees, set the brightness level of the display to 1100 nits in operation 911. The electronic device 101 may, based on the temperature change rate exceeding 1.0 degree (a fourth case) in a temperature higher than 37 degrees and less than 38 degrees, set the brightness level of the display to 900 nits in operation 917.

In an embodiment, based on identifying the temperature equal to or greater than the fourth temperature (operation 913-No), the electronic device 101 may, in operation 919, identify whether the temperature is less than a fifth temperature higher than the fourth temperature. The fifth temperature may, for example, be 39 degrees but there is no limitation. Based on identifying the temperature less than the fifth temperature (operation 919-Yes), the electronic device 101 may, in operation 921, identify a case corresponding to the temperature change rate of the electronic device 101. The electronic device 101 may, for example, based on the temperature change rate being equal to or less than 0.2 degrees (the first case) at a temperature higher than 38 degrees and less than 39 degrees, set the brightness level of the display to 1300 nits in operation 905. The electronic device 101 may, based on the temperature change rate being between 0.2 degrees and 0.6 degrees (the second case) at a temperature higher than 38 degrees and less than 39 degrees, set the brightness level of the display to 1100 nits in operation 911. The electronic device 101 may, based on the temperature change rate exceeding 0.6 degree (the third case and the fourth case) in a temperature higher than 38 degrees and less than 39 degrees, set the brightness level of the display to 900 nits in operation 917.

In an embodiment, based on identifying the temperature equal to or greater than the fifth temperature (operation 919-No), the electronic device 101 may, in operation 923, identify whether the temperature is less than the second temperature higher than the fifth temperature. The second temperature may, for example, be 40 degrees but there is no limitation. Based on identifying the temperature less than the second temperature (operation 923-Yes), the electronic device 101 may, in operation 925, identify a case corresponding to the temperature change rate of the electronic device 101. The electronic device 101 may, for example, based on the temperature change rate being equal to or less than 0.2 degrees (the first case) at a temperature higher than 39 degrees and less than 40 degrees, set the brightness level of the display to 1100 nits in operation 911. The electronic device 101 may, based on the temperature change rate exceeding 0.2 degree (the second case, the third case, and the fourth case) in a temperature higher than 39 degrees and less than 40 degrees, set the brightness level of the display to 900 nits in operation 917.

In an embodiment, based on identifying the temperature equal to or greater than the second temperature (operation 923-No), the electronic device 101 may, in operation 927, set the brightness level of the display to 400 nits.

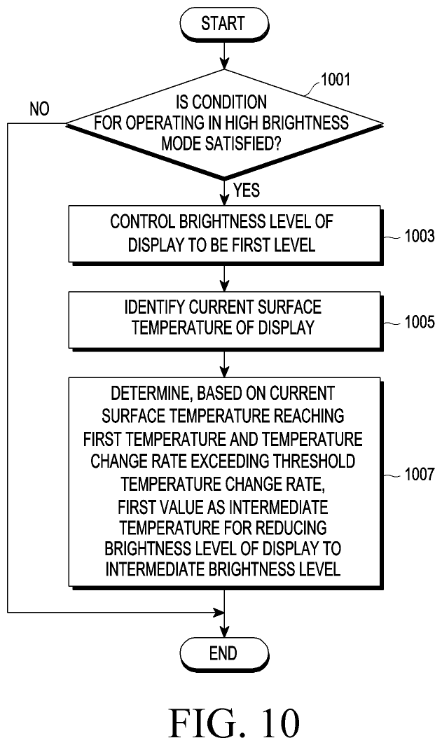

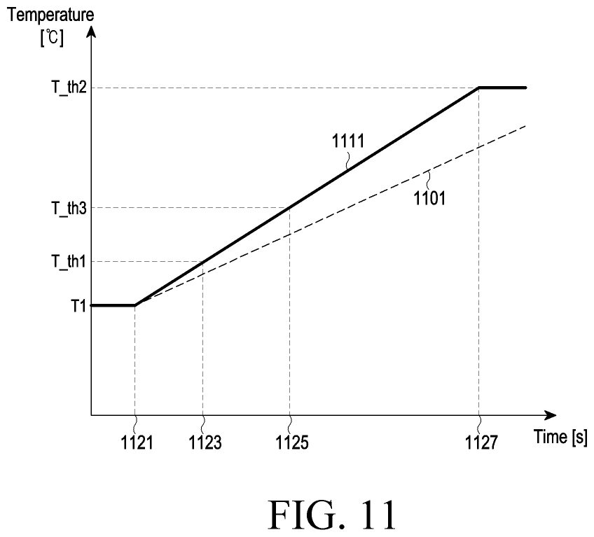

FIG. 10 is a flowchart illustrating an example method for controlling a brightness level of a display of an electronic device according to various embodiments. FIG. 10 will be described with reference to FIG. 11. FIG. 11 is a diagram illustrating an example method for controlling a brightness level of a display of an electronic device according to various embodiments.

Referring to FIG. 10, in operation 1001, according to an embodiment, the electronic device 101 (e.g., the processor 250 in FIG. 2) may, based on a brightness obtained through an illuminance sensor 176 of the electronic device 101 configured to measure an amount of light incident on the electronic device 101, identify whether a condition for operating in a high brightness mode is satisfied. The condition for operating in the high brightness mode may include a case that the brightness exceeds a threshold brightness. The condition for operating in the high brightness mode may include a case that the high brightness mode is set to be activated.

In operation 1003, according to an embodiment, the electronic device 101 may control the brightness level of the display 210 to the first level, based on identifying the condition for operating in the high brightness mode being satisfied. Referring to FIG. 11, the electronic device 101 may set the brightness level of the display to the first level at a time point 1121 of identifying the condition for operating in the high brightness mode being satisfied.

In operation 1005, according to an embodiment, the electronic device 101 may identify a current surface temperature of the display 210 based on the temperature obtained using at least one sensor 220 while controlling the brightness level of the display 210 to the first level.

In operation 1007, according to an embodiment, the electronic device 101 may, based on the current surface temperature reaching the first temperature and the temperature change rate being greater than the threshold temperature change rate, determine the intermediate temperature for reducing the brightness level of the display 210 to the intermediate brightness level. Referring to FIG. 11, the electronic device 101 may, based on the temperature change rate 1111 exceeding the threshold temperature change rate 1101 and the current surface temperature reaching the first temperature T_th1, determine the intermediate temperature to be the first temperature. The electronic device 101 may start the brightness control at a time point 1123 when the current surface temperature reaches the first temperature. The electronic device 101 may use the temperature change rate identified before the current surface temperature reaches the first temperature in order to reduce the brightness level of the display at the time point 1123 when the current surface temperature reaches the first temperature. The electronic device 101 may, for example, reduce the brightness level of the display to the first intermediate brightness level. The electronic device 101 may reduce the brightness level of the display to the second intermediate brightness level at a time point 1125 of identifying the temperature change rate 1111 exceeding the threshold temperature change rate 1101 and the current surface temperature reaches the third temperature T_th3. The electronic device 101 may reduce the brightness level of the display to the second level at a time point 1127 of identifying the temperature change rate 1111 exceeding the threshold temperature change rate 1101 and the current surface temperature reaches the second temperature T_th2.

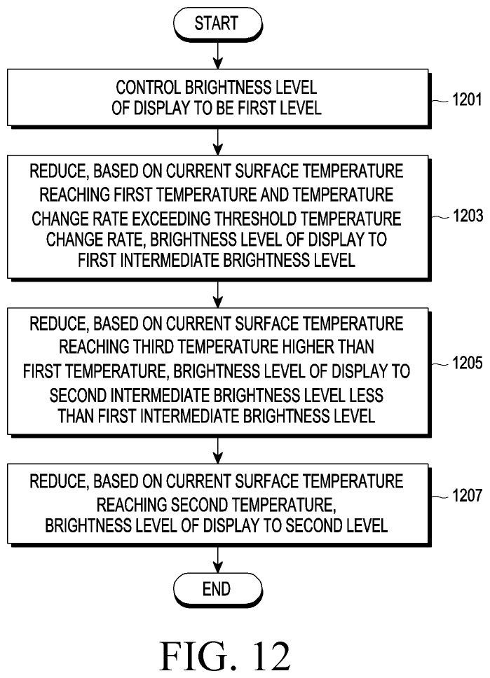

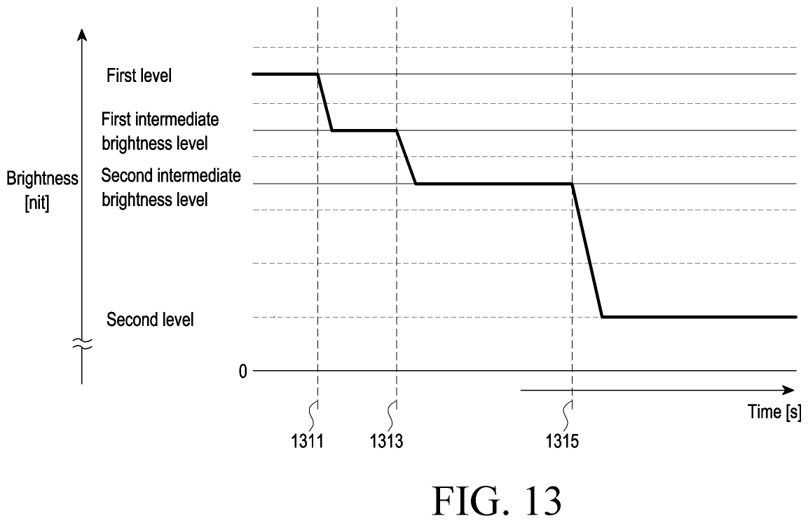

FIG. 12 is a flowchart illustrating an example method for controlling a brightness level of a display of an electronic device according to various embodiments. FIG. 12 will be described with reference to FIG. 13. FIG. 13 is a graph illustrating an example method for controlling a brightness level of a display of an electronic device according to various embodiments.

In operation 1201, in an embodiment, the electronic device 101 (e.g., the processor 250 in FIG. 2) may control the brightness level of the display to be the first level. The electronic device 101 may, for example, the brightness level of the display to be the maximum brightness level, based on ambient light exceeding a threshold brightness in the high brightness mode.

In operation 1203, according to an embodiment, the electronic device 101 may, based on the current surface temperature reaching the first temperature and the temperature change rate being greater than the threshold temperature change rate, reduce the brightness level of the display 210 to the first intermediate brightness level set for securing visibility of the display in the high brightness mode. Referring to FIG. 13, the electronic device 101 may, based on the temperature change rate exceeding the threshold temperature change rate, reduce the brightness level of the display to the first intermediate brightness level at a time point 1311 when the current surface temperature reaches the first temperature. In an embodiment, the temperature change rate may be a temperature change rate measured at a time point 1311 when the current surface temperature reaches the first temperature. The temperature change rate may be a temperature change rate measured before the current surface temperature reaches the first temperature. The temperature change rate may be one of one or more temperature change rates periodically identified while the surface temperature of the electronic device 101 increases.

In operation 1205, in an embodiment, the electronic device 101 may, based on the current surface temperature reaching the third temperature higher than the first temperature, reduce the brightness level of the display 210 to the second intermediate brightness level less than the first intermediate brightness level.

In an embodiment, the electronic device 101 may, based on the current surface temperature and the temperature change rate, reduce the brightness level of the display 210 to the second intermediate brightness level. Referring to FIG. 13, the electronic device 101 may, based on the temperature change rate exceeding the threshold temperature change rate, reduce the brightness level of the display to the second intermediate brightness at a time point 1313 when the current surface temperature reaches the third temperature. In an embodiment, the temperature change rate which the electronic device 101 refers to to control the brightness level of the display may be a temperature change rate measured at a time point 1311 when the surface temperature of the electronic device 101 reaches the first temperature. The temperature change rate may be a temperature change rate measured at a time point when the surface temperature reaches the third temperature. The temperature change rate may be one of one or more temperature change rates periodically identified while the surface temperature of the electronic device 101 sequentially increases to the third temperature.

In operation 1207, in an embodiment, the electronic device 101 may, based on the current surface temperature reaching the second temperature, reduce the brightness level of the display 210 to the second level. Referring to FIG. 13, the electronic device 101 may reduce the brightness level of the display to the second level at a time point 1315 when the current surface temperature reaches the second temperature.

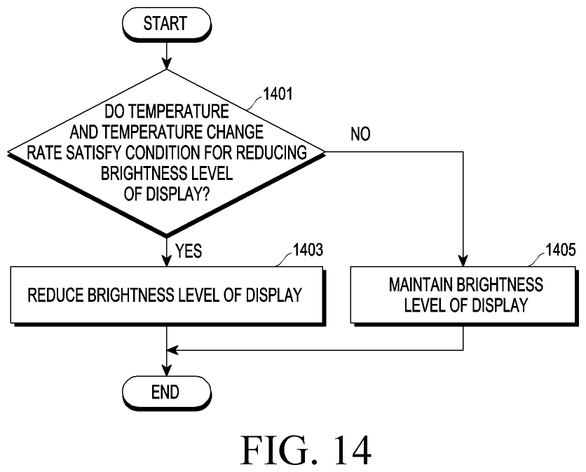

FIG. 14 is a flowchart illustrating an example method for controlling a brightness level of a display of an electronic device according to various embodiments.

In an embodiment, the electronic device 101 may determine a policy for reducing the brightness level of the display, based on one or more temperature change rates periodically identified while the temperature of the electronic device 101 increases sequentially based on the temperature of the electronic device 101 exceeding a designated temperature.

Referring to FIG. 14, in operation 1401, the electronic device 101 (e.g., the processor 250 in FIG. 2) may, based on a time period set to periodically identify the temperature change rate, identify whether the temperature and the temperature change rate of the electronic device 101 satisfy the condition for reducing the brightness level of the display 210. The electronic device 101 may, based on identifying the brightness level set in response to the temperature and the temperature change rate of the electronic device 101, for example, identify whether to reduce the brightness level of the display.

In operation 1403, according to an embodiment, the electronic device 101 may, based on identifying the temperature and the temperature change rate satisfying the condition, reduce the brightness level of the display 210.

In operation 1405, according to an embodiment, the electronic device 101 may, based on identifying the temperature and the temperature change rate not satisfying the condition, maintain the brightness level of the display 210. At least a portion of operations 1401 to 1405 may be perform at set periods to determine the temperature change rate. In an embodiment, the electronic device 101 may, based on the temperature measured based on the temperature of the electronic device 101 reaching the first temperature instead of periodically identified one or more temperature change rates, control the brightness level of the display to brightness levels corresponding to designated temperatures. For example, the electronic device 101 may identify a policy for reducing the brightness level of the display when the temperature of the electronic device 101 reaches the first temperature, and control the brightness level of the display based on the identified policy until the temperature of the electronic device 101 reaches the second temperature.

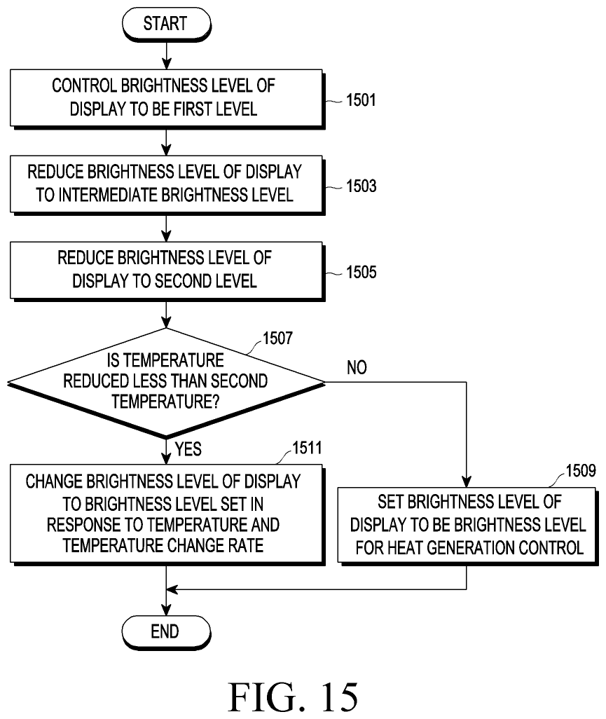

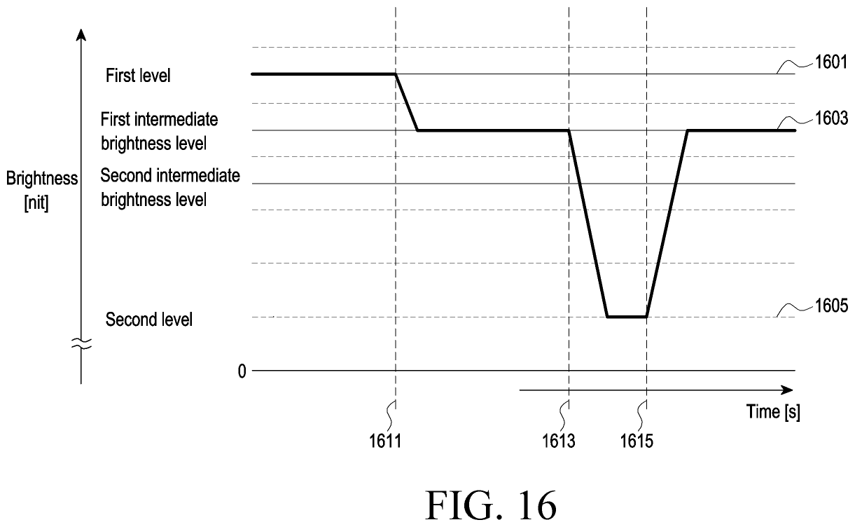

FIG. 15 is a flowchart illustrating an example method for controlling a brightness level of a display of an electronic device according to various embodiments. FIG. 15 will be described with reference to FIG. 16. FIG. 16 is a graph illustrating an example method for controlling a brightness level of a display of an electronic device according to various embodiments.

Referring to FIG. 15, in operation 1501, in an embodiment, the electronic device 101 (e.g., the processor 250 in FIG. 2) may control the brightness level of the display to be the first level.

In operation 1503, in an embodiment, the electronic device 101 may reduce the brightness level of the display to the intermediate level. Referring to FIG. 16, the electronic device 101 may, based on the temperature change rate being less than the threshold temperature change rate, reduce the brightness level of the display from the first level 1601 to the first intermediate brightness level 1603 at a time point 1611 when the temperature of the electronic device 101 reaches the third temperature higher than the first temperature.

In operation 1505, in an embodiment, the electronic device 101 may reduce the brightness level of the display to the second level. The electronic device 101 may, based on the temperature change rate being less than the threshold temperature change rate, reduce the brightness level of the display to the second level 1605 at a time point 1613 when the temperature of the electronic device 101 reaches the second temperature.

In operation 1507, in an embodiment, the electronic device 101 may identify whether the temperature decreases less than the second temperature after reducing the brightness level of the display 210 to the second level.

In an embodiment, based on identifying the temperature not decreasing less than the second temperature (operation 1507-No), the electronic device 101 may, in operation 1509, set the brightness level of the display to the brightness level for heat generation control. The electronic device 101 may, for example, remain the brightness level of the display at the second level.

In an embodiment, based on identifying the temperature decreasing less than the second temperature (operation 1507-Yes), the electronic device 101 may, in operation 1511, change the brightness level of the display 210 to a brightness level set in response to the temperature and the temperature change rate. Referring to FIG. 16, the electronic device 101 may increase the brightness level of the display to the first intermediate brightness level 1603 at a time point 1615 when the temperature decreases less than the second temperature.

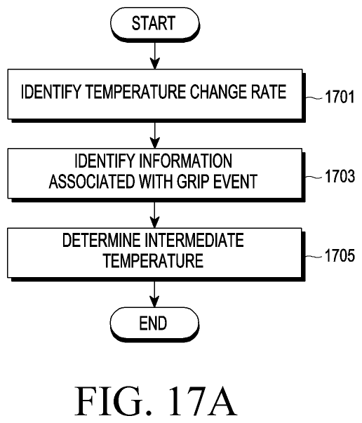

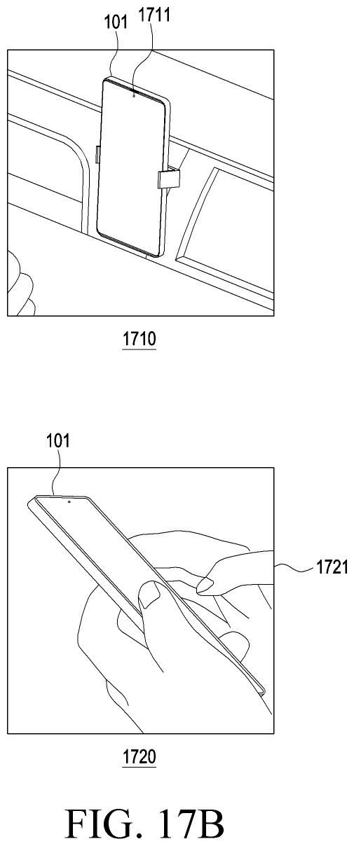

FIG. 17A is a flowchart illustrating an example method for setting an intermediate temperature for controlling a brightness level of a display of an electronic device according to various embodiments. FIG. 17A will be described with reference to FIG. 17B. FIG. 17B is a diagram illustrating an example method for identifying a grip event of an electronic device according to various embodiments.

Referring to FIG. 17A, in operation 1701, in an embodiment, the electronic device 101 (e.g., the processor 250 in FIG. 2) may identify the temperature change rate of the electronic device 101. The electronic device 101 may, based on, for example, the temperature of the electronic device 101 reaching the first temperature, determine the temperature change rate of the electronic device. According to an embodiment, in operation 1703, the electronic device 101 may, based on a sensing value obtained through a grip sensor (e.g., the grip sensor 176), identify information associated with a grip event of the electronic device 101. In an embodiment, the electronic device 101 may identify that the electronic device 101 is gripped by a user of the electronic device 101 as the grip event of the electronic device 101. The electronic device 101 may, for example, based on the sensing value of the grip sensor, identify that the electronic device 101 is gripped.

According to an embodiment, in operation 1705, the electronic device 101 may, based on the identified temperature change rate and the information associated with the grip event, determine an intermediate temperature. If the temperature change rate is greater than a threshold temperature change rate and the grip event has not occurred, the intermediate temperature may be set to a third value greater than the first value. For example, the electronic device 101 may determine, as the intermediate temperature, a temperature higher than a set intermediate temperature (e.g., 37 degrees, 38 degrees, or 39 degrees).

Referring to FIG. 17B, in an embodiment, the electronic device 101 may, based on a use environment (e.g., the electronic device 101 is gripped) of the electronic device 101, improve the usability by changing setting of the threshold temperature. Referring to reference number 1710, the electronic device 101 may, in a state where the electronic device 101 is not gripped, change setting of a temperature such that a temperature for reducing the brightness level of the display to the second level is increased above the second temperature (e.g., 40 degrees). The electronic device 101 may identify occurrence of an event for changing the setting of the threshold temperature using the front camera 1711. Referring to reference number 1720, the electronic device 101 may, based on identifying the electronic device 101 in contact with the body 1721 of the user, maintain the setting of the threshold temperature.

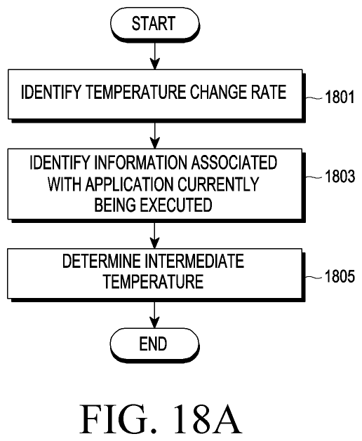

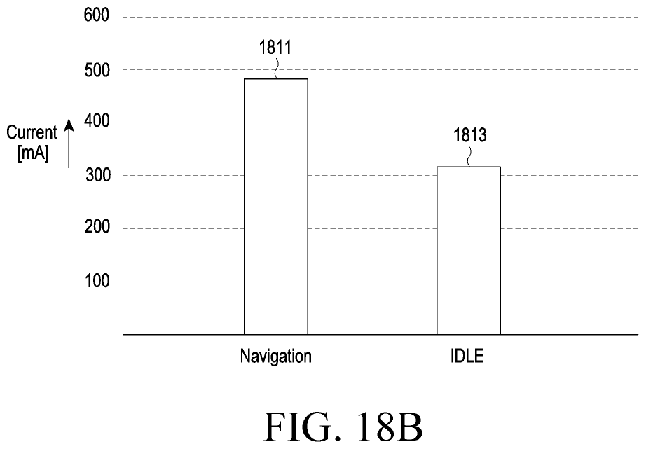

FIG. 18A is a flowchart illustrating an example method for setting an intermediate temperature for controlling a brightness level of a display of an electronic device according to various embodiments. FIG. 18A will be described with reference to FIG. 18B. FIG. 18B is a graph illustrating example current consumption according to an operation of an electronic device according to various embodiments.

Referring to FIG. 18A, in operation 1801, in an embodiment, the electronic device 101 (e.g., the processor 250 in FIG. 2) may identify the temperature change rate of the electronic device 101. The electronic device 101 may, based on, for example, the temperature of the electronic device 101 reaching the first temperature, determine the temperature change rate of the electronic device.

According to an embodiment, in operation 1803, the electronic device 101 may identify information associated with an application currently being executed. In an embodiment, the electronic device 101 may identify identification information associated with an application currently being executed. The electronic device 101 may identify, for example, a package name of an application being executed in a foreground. The electronic device 101 may identify a type of an application currently being executed. For example, the type of the application may include an Internet browser, streaming application, or navigation application.

According to an embodiment, in operation 1805, the electronic device 101 may, based on the information associated with the application currently being executed and the identified temperature change rate, determine an intermediate temperature. If the temperature change rate is greater than a threshold temperature change rate and the application currently being executed is a specified application, the intermediate temperature may be set to a third value greater than the first value. For example, the electronic device 101 may determine, in case that the application currently being executed is the navigation application, a temperature higher than a set intermediate temperature (e.g., 37 degrees, 38 degrees, or 39 degrees) as the intermediate temperature.

Referring to FIG. 18B, a current consumption amount 1811 in case that a navigation service is provided may be greater than a current consumption amount 1813 in case that the electronic device 101 is in an idle state. The idle state may include a state where the electronic device 101 provides a home screen. The electronic device 101 may, based on the possibility of heat generation in an environment where the navigation service is used (e.g., the grip event of the electronic device 101 has not occurred), change the setting of the threshold temperature. The electronic device 101 may increase each of the first temperature, the third temperature, the fourth temperature, the fifth temperature, and the second temperature by one degree.

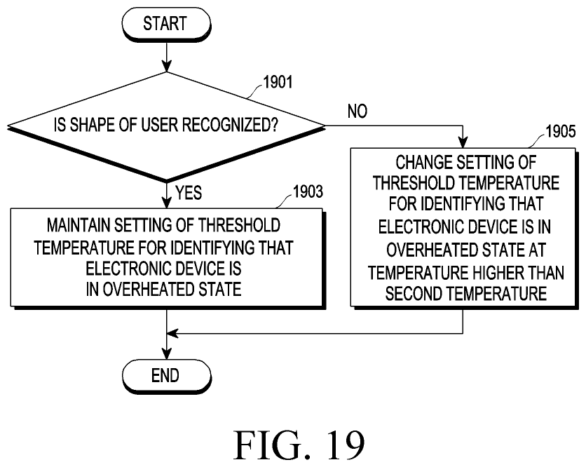

FIG. 19 is a flowchart illustrating an example method for setting a threshold temperature for controlling a brightness level of a display of an electronic device according to various embodiments.

Referring to FIG. 19, in operation 1901, according to an embodiment, the electronic device 101 (e.g., the processor 250 in FIG. 2) may, based on an image obtained through a camera 230 of the electronic device 101, identify whether a shape of the user of the electronic device 101 is recognized in the image. The electronic device 101 may identify, for example, whether a face shape is identified within a preview image obtained using a front camera. The electronic device 101 may identify whether a touch event is identified.

In an embodiment, based on identifying the shape of the user being recognized (operation 1901-Yes), the electronic device 101 may, in operation 1903, maintain the setting of the threshold temperature for identifying that the electronic device is in an overheated state.

In an embodiment, based on identifying the shape of the user not being recognized in the image (operation 1901-No), the electronic device 101 may, in operation 1905, change the setting of the threshold temperature for identifying whether the electronic device 101 is in the overheated state to a temperature higher than the second threshold temperature.

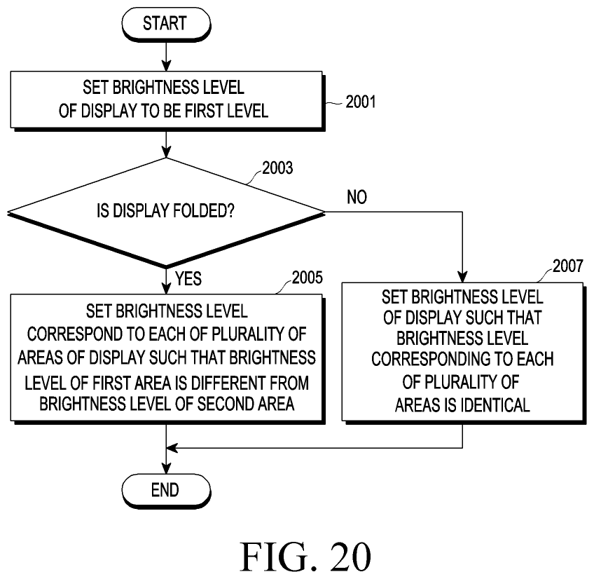

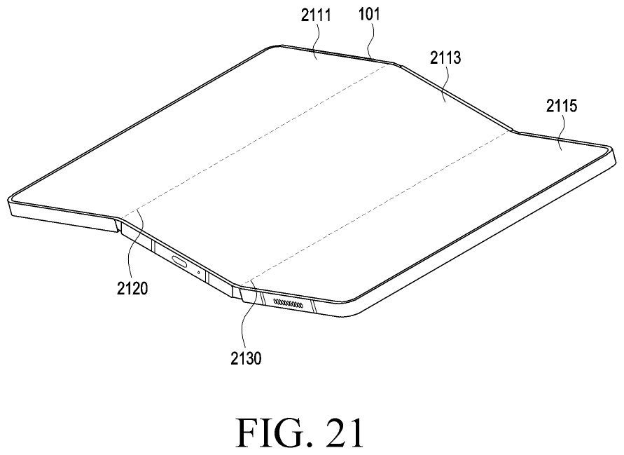

FIG. 20 is a flowchart illustrating an example method for controlling a brightness level of a display of an electronic device according to various embodiments. FIG. 20 will be described with reference to FIG. 21. FIG. 21 is a diagram illustrating an example method for controlling a brightness level of a display of an electronic device according to various embodiments.

Referring to FIG. 20, in operation 2001, in an embodiment, the electronic device 101 (e.g., the processor 250 in FIG. 2) may set the brightness level of the display to the first brightness level. The display 210 may be a foldable display including a plurality of areas separated by at least one folding line. Referring to FIG. 21, the display may include a first area 2111, a second area 2113, and a third area 2115. The first area 2111 may be separated from the second area 2113 by a first folding line 2120. The second area 2113 may be separated from the third area 2115 by a second folding line 2130.

In operation 2003, in an embodiment, the electronic device 101 may identify whether the display is folded. The electronic device 101 may identify whether the display is folded using, for example, a sensor module.

In an embodiment, based on identifying the display being folded (operation 2003-Yes), the electronic device 101 may, in operation 2005, set the brightness level corresponding to each of the plurality of areas of the display 210 such that a brightness level of the first area among the plurality of areas is different from a brightness level of the second area different from the first area among the plurality of areas. The first area may be, for example, an area to which an amount of incident light exceeds a set threshold brightness.

In an embodiment, based on identifying the display not being folded (operation 2003-No), the electronic device 101 may, in operation 2007, set the brightness level of the display 210 such that a brightness level corresponding to each of the plurality of areas is identical.

The electronic device (e.g., the electronic device 101 in FIG. 2) according to an example embodiment may include at least one sensor (e.g., the sensor 220 in FIG. 2) configured to output information associated with the temperature of the electronic device 101. The electronic device 101 may include a display (e.g., the display 210 in FIG. 2). The electronic device 101 may include at least one processor (e.g., the processor 250) including processing circuitry. The electronic device may include memory (e.g., the memory 240 in FIG. 2) configured to store instructions. The instructions, when executed by the at least one processor individually or collectively, may cause the electronic device to, based on a brightness level of the display being set to be a first level based on an ambient light level and based on a temperature of the electronic device determined using the at least one sensor reaching a first temperature, identify a temperature change rate within a designated time period and determine an intermediate temperature between the first temperature and a second temperature higher than the first temperature, for reducing a brightness level of the display to an intermediate brightness level between the first level and a second level less than the first level, based on the identified temperature change rate. Based on the temperature change rate being greater than a threshold temperature change rate, the intermediate temperature may be set to a first value. Based on the temperature change rate being less than the threshold temperature change rate, the intermediate temperature may be set to a second value greater than the first value. The instructions, when executed by the at least one processor individually or collectively, may cause the electronic device to, based on the current temperature of the electronic device reaching the intermediate temperature, reduce the brightness level of the display to the intermediate brightness level. The instructions, when executed by the at least one processor individually or collectively, may cause the electronic device to, based on the current temperature reaching the second temperature, reduce the brightness level of the display to the second brightness level.

The instructions, when executed by the at least one processor individually or collectively, may cause the electronic device to, based on the temperature of the electronic device reaching the intermediate temperature, reduce the brightness level of the display according to a plurality of time periods such that the brightness level of the display is controlled to be identical during one or more adjacent time points among the plurality of time periods.

In an example embodiment, the at least one sensor may include at least one thermistor. The display may include an AMOLED display.

In an example embodiment, the instructions may, when executed by the at least one processor individually or collectively, cause the electronic device to: based on a brightness obtained through an illuminance sensor of the electronic device configured to measure an amount of light incident on the electronic device, identify whether a condition for operating in a high brightness mode is satisfied. The instructions, when executed by the at least one processor individually or collectively, may cause the electronic device to, based on identifying the condition for operating in the high brightness mode being satisfied, control the brightness level of the display to the first level. The instructions, when executed by the at least one processor individually or collectively, may cause the electronic device to, identify a current surface temperature of the display based on the temperature obtained using the at least one sensor while controlling the brightness level of the display to the first brightness level. The instructions, when executed by the at least one processor individually or collectively, may cause the electronic device to, based on the current surface temperature reaching the first temperature and the temperature change rate being greater than the threshold temperature change rate, determine a first value as the intermediate temperature for reducing the brightness level of the display to the intermediate brightness level.

In an example embodiment, the instructions, when executed by the at least one processor individually or collectively, may cause the electronic device to, based on the current surface temperature reaching the first temperature and the temperature change rate being greater than the threshold temperature change rate, reduce the brightness level of the display to a first intermediate brightness level set for securing visibility of the display in the high brightness mode. The instructions, when executed by the at least one processor individually or collectively, may cause the electronic device to, based on the current surface temperature reaching a third temperature higher than the first temperature, reduce the brightness level of the display to a second intermediate brightness level less than the first intermediate brightness level. The instructions, when executed by the at least one processor individually or collectively, may cause the electronic device to, based on the current temperature reaching the second temperature, reduce the brightness level of the display to the second brightness level.

In an example embodiment, the instructions, when executed by the at least one processor individually or collectively, may cause the electronic device to, based on a time period set for identifying the temperature change rate periodically, identify whether the temperature and the temperature change rate satisfy a condition for reducing the brightness level of the display. The instructions, when executed by the at least one processor individually or collectively, may cause the electronic device to, based on identifying the temperature and the temperature change rate satisfying the condition, reduce the brightness level of the display. The instructions, when executed by the at least one processor individually or collectively, may cause the electronic device to, based on identifying the temperature and the temperature change rate not satisfying the condition, maintain the brightness level of the display.

The instructions, when executed by the at least one processor individually or collectively, may cause the electronic device to identify whether the temperature decreases less than the second temperature after reducing the brightness level of the display to the second level. The instructions, when executed by the at least one processor individually or collectively, may cause the electronic device to, based on identifying the temperature decreasing less than the second temperature, change the brightness level of the display to a brightness level set in response to the temperature and the temperature change rate.

In an example embodiment, the instructions, when executed by the at least one processor individually or collectively, may cause the electronic device to, based on a sensing value obtained through the grip sensor of the electronic device, identify information associated with a grip event of the electronic device. The instructions, when executed by the at least one processor individually or collectively, may cause the electronic device to, based on the identified temperature change rate and the information associated with the grip event, determine the intermediate temperature. If the temperature change rate is greater than a threshold temperature change rate and the grip event has not occurred, the intermediate temperature may be set to a third value greater than the first valuc.

In an example embodiment, the instructions, when executed by the at least one processor individually or collectively, may cause the electronic device to identify information associated with an application currently being executed. The instructions, when executed by the at least one processor individually or collectively, may cause the electronic device to, based on the information associated with the application currently being executed and the identified temperature change rate, determine the intermediate temperature. If the temperature change rate is greater than a threshold temperature change rate and the application currently being executed is a specified application, the intermediate temperature may be set to a third value greater than the first value.

In an example embodiment, the instructions, when executed by the at least one processor individually or collectively, may cause the electronic device to, based on an image obtained through a camera of the electronic device, identify whether a shape of the user of the electronic device is recognized in the image. The instructions, when executed by the at least one processor individually or collectively, may cause the electronic device to, based on identifying the shape of the user not being recognized in the image, change a configuration of a threshold temperature for identifying whether the electronic device is in the overheated state to a temperature higher than the second threshold temperature.

In an example embodiment, the display 210 may include a foldable display including a plurality of areas separated by at least one folding line. The instructions, when executed by the at least one processor individually or collectively, may cause the electronic device to, based on the display being unfolded, set the brightness level of the display such that a brightness level corresponding to each of the plurality of arcas is identical. The instructions, when executed by the at least one processor individually or collectively, may cause the electronic device to, based on the display being folded, set the brightness level corresponding to each of the plurality of areas of the display such that a brightness level of the first area among the plurality of areas is different from a brightness level of the second area different from the first area among the plurality of areas. The first area may be an area to which an amount of incident light exceeds a set threshold brightness.

A method of operating an electronic device according to an example embodiment may include: based on a brightness level of a display of the electronic device being set to be a first level based on an ambient light level and based on a temperature of the electronic device identified using at least one sensor of the electronic device reaching a first temperature, identifying a temperature change rate within a designated time period and determining an intermediate temperature between the first temperature and a second temperature higher than the first temperature, to reduce a brightness level of the display to an intermediate brightness level between the first level and a second level less than the first level, based on the identified temperature change rate. Based on the temperature change rate being greater than a threshold temperature change rate, the intermediate temperature may be set to a first value. Based on the temperature change rate being less than the threshold temperature change rate, the intermediate temperature may be set to a second value greater than the first value. The method may include, based on the current temperature of the electronic device reaching the intermediate temperature, reducing the brightness level of the display to the intermediate brightness level. The method may include, based on the current temperature reaching the second temperature, reducing the brightness level of the display to the second level.

In an example embodiment, based on the temperature of the electronic device identified using the at least one sensor of the electronic device reaching the first temperature, identifying the temperature change rate within the designated time period and determining the intermediate temperature, between the first temperature and the second temperature higher than the first temperature, to reduce brightness level of the display to the intermediate brightness level between the first level and the second level less than the first level, based on the identified temperature change rate may include, based on the temperature reaching the intermediate temperature, reducing the brightness level of the display according to the plurality of time periods such that the brightness level of the display is controlled to be identical during one or more adjacent time points among the plurality of time periods.

In an example embodiment, the at least one sensor (220) may include at least one thermistor. The display may include an AMOLED display.

In an example embodiment, the method may further include, based on a brightness obtained through an illuminance sensor of the electronic device configured to measure an amount of light incident on the electronic device, identifying whether a condition for operating in a high brightness mode is satisfied. The controlling the brightness level of the display of the electronic device to be the first level may include, based on identifying the condition for operating in the high-brightness mode being satisfied, controlling the brightness level of the display to be the first level. The operation of, based on the temperature of the electronic device identified using the at least one sensor of the electronic device reaching the first temperature, identifying the temperature change rate within the designated time period and determining the intermediate temperature, between the first temperature and the second temperature higher than the first temperature, to reduce brightness level of the display to the intermediate brightness level between the first level and the second level less than the first level, based on the identified temperature change rate may include, based on the temperature obtained using the at least one sensor, identifying a current surface temperature of the display while controlling the brightness level of the display to the first level. The operation of, based on the temperature of the electronic device reaching the first temperature, identifying the temperature change rate within the designated time period and reducing, based on the identified temperature change rate, the brightness level of the display to the intermediate level between the first level and the second level less than the first level may include, based on the current surface temperature reaching the first temperature and the temperature change rate being greater than the threshold temperature change rate, determining a first value as the intermediate temperature for reducing the brightness level of the display to the intermediate brightness level.

In an example embodiment, the operation of, based on the temperature of the electronic device reaching the intermediate temperature, reducing the brightness level of the display to the intermediate brightness level may include, based on the current surface temperature reaching the first temperature and the temperature change rate being greater than the threshold temperature change rate, reducing the brightness level of the display to a first intermediate brightness level set for securing visibility of the display in the high brightness mode. The operation of, based on the temperature reaching the intermediate temperature, reducing the brightness level of the display to the intermediate brightness level may include, based on the current surface temperature reaching a third temperature higher than the first temperature, reducing the brightness level of the display to a second intermediate brightness level less than the first intermediate brightness level.

In an example embodiment, the method may further include, based on a time period set for identifying the temperature change rate periodically, identifying whether the temperature and the temperature change rate satisfy a condition for reducing the brightness level of the display. The method may include, based on identifying the temperature and the temperature change rate satisfying the condition, reducing the brightness level of the display. The method may include, based on identifying the temperature and the temperature change rate not satisfying the condition, maintain the brightness level of the display.

In an example embodiment, the method may include identifying information associated with an application currently being executed. The method may further include, based on the information associated with the application currently being executed and the identified temperature change rate, determining the intermediate temperature.

According to an example embodiment a non-transitory computer-readable storage medium configured to store computer-executable instructions is provided, wherein computer-executable instructions, when executed by at least one processor including processing circuitry individually or collectively, may cause an electronic device to: based on a brightness level of a display of an electronic device being set to be a first level based on an ambient light level and when a temperature of the electronic device identified using at least one sensor of the electronic device reaching a first temperature, identify a temperature change rate within a designated time period and determine an intermediate temperature between the first temperature and a second temperature higher than the first temperature, to reduce a brightness level of the display to an intermediate brightness between the first level and a second level less than the first level, based on the identified temperature change rate. Based on the temperature change rate being greater than a threshold temperature change rate, the intermediate temperature may be set to a first value. Based on the temperature change rate being less than the threshold temperature change rate, the intermediate temperature may be set to a second value greater than the first value. The computer-executable instructions may, when executed by the at least one processor individually or collectively, based on the current temperature of the electronic device reaching the intermediate temperature, cause the electronic device to reduce the brightness level of the display to the intermediate brightness level. The computer-executable instructions, when executed by the at least one processor individually or collectively, based on the current temperature reaching the second temperature, may cause the electronic device to reduce the brightness level of the display to the second level.

Also, the structure of data used in the above-described embodiments of the disclosure may be recorded in a computer-readable recording medium via various means. The computer-readable recording medium may include a storage medium such as a magnetic storage medium (e.g., a ROM, floppy disk, hard disk, or the like) and an optical reading medium (e.g., a CD-ROM, DVD, or the like).

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
at least one sensor configured to output information associated with a temperature of the electronic device;
a display;
at least one processor including processing circuitry; and
memory storing instructions, wherein the instructions, when executed by the at least one processor individually or collectively, cause the electronic device to:
based on a brightness level of the display being set to a first level based on an ambient light level:
based on a temperature of the electronic device identified using the at least one sensor reaching a first temperature, identify a temperature change rate within a specified time interval and determine an intermediate temperature, between the first temperature and a second temperature higher than the first temperature, to reduce brightness level of the display to an intermediate brightness level, between the first level and a second level less than the first level, based on the identified temperature change rate, wherein, based on the temperature change rate being greater than a threshold temperature change rate, the intermediate temperature is set to a first value, and based on the temperature change rate being less than the threshold temperature change rate, the intermediate temperature is set to a second value greater than the first value;
based on a current temperature of the electronic device reaching to the intermediate temperature, reduce the brightness level of the display to the intermediate brightness level; and
based on the current temperature reaching to the second temperature, reduce the brightness level of the display to the second level.

2. The electronic device of claim 1,
wherein the instructions, when executed by the at least one processor individually or collectively, cause the electronic device to:
based on the temperature of the electronic device reaching the first temperature, reduce the brightness level of the display according to a plurality of time periods such that a luminance of the display is controlled to be identical during one or more adjacent time points among the plurality of time periods.

3. The electronic device of claim 1,
wherein the at least one sensor includes at least one thermistor, and
wherein the display includes an active-matrix organic light emitting diode (AMOLED) display.

4. The electronic device of claim 1,
wherein the instructions, when executed by the at least one processor individually or collectively, cause the electronic device to:
based on an illuminance obtained through a photoresistor of the electronic device configured to measure an amount of light incident on the electronic device, identify whether a condition for operating in a high-brightness mode is satisfied,
based on identifying the condition for operating in the high-brightness mode being satisfied, control the brightness level of the display to be the first level,
while controlling the brightness level of the display to be the first level, identify a current surface temperature of the display based on the temperature obtained using the at least one sensor, and
based on the current surface temperature reaching the first temperature and the temperature change rate being greater than the threshold temperature change rate, determine, to a first value, the intermediate temperature for reducing the brightness level of the display.

5. The electronic device of claim 1,
wherein the instructions, when executed by the at least one processor individually or collectively, cause the electronic device to:
based on the current surface temperature reaching the first temperature and the temperature change rate exceeding the threshold temperature change rate, reduce the brightness level of the display to a first intermediate brightness level set for securing visibility of the display in the high brightness mode,
based on the current surface temperature reaching a third temperature higher than the first temperature, reduce the brightness level of the display to a second intermediate brightness level lower than the first intermediate brightness level, and
based on the current surface temperature reaching the second temperature, reduce the brightness level of the display to the second brightness level.

6. The electronic device of claim 1,
wherein the instructions, when executed by the at least one processor individually or collectively, cause the electronic device to:
based on a time period set for identifying the temperature change rate periodically, identify whether the temperature and the temperature change rate satisfy a condition for reducing the brightness level of the display,
based on identifying the temperature and the temperature change rate satisfying the condition, reduce the brightness level of the display, and
based on identifying the temperature and the temperature change rate not satisfying the condition, maintain the brightness level of the display.

7. The electronic device of claim 1,
wherein the instructions, when executed by the at least one processor individually or collectively, cause the electronic device to:
based on controlling the brightness level of the display to the second brightness level, identify whether the temperature decreases less than the second temperature, and
based on identifying the temperature decreasing less than the second temperature, increase the brightness level of the display to a brightness level set corresponding to the temperature and the temperature change rate.

8. The electronic device of claim 1,
wherein the instructions, when executed by the at least one processor individually or collectively, cause the electronic device to:
based on a sensing value obtained through a grip sensor of the electronic device, identify information associated with a grip event of the electronic device, and
determine the intermediate temperature based on the identified temperature change rate and the information associated with the grip event, and
wherein based on the temperature change rate being greater than a threshold temperature change rate and the grip event not occurring, the intermediate temperature is set to a third value greater than the first value.

9. The electronic device of claim 1,
wherein the instructions, when executed by the at least one processor individually or collectively, cause the electronic device to:
identify information associated with an application currently being executed, and
based on the information associated with the application currently being executed and the identified temperature change rate, determine the intermediate temperature, and
wherein based on the temperature change rate being greater than a threshold temperature change rate and the application currently being executed being a specified application, the intermediate temperature is set to a third value greater than the first value.

10. The electronic device of claim 1,
wherein the instructions, when executed by the at least one processor individually or collectively, cause the electronic device to:
based on an image obtained through a camera of the electronic device, identify whether a shape of a user of the electronic device is recognized in the image, and
based on identifying the shape of the user not being recognized in the image, change a setting of a threshold temperature for identifying whether a state of the electronic device is an overheating state such that the threshold temperature to be a temperature higher than the second threshold temperature.

11. The electronic device of claim 1,
wherein the display includes a foldable display including a plurality of areas separated by at least one folding line, and
wherein at least one processor individually or collectively, is configured to cause the electronic device to:
based on the display being unfolded, set the brightness level of the display such that a brightness level corresponding to each of the plurality of areas is identical, and
based on the display being folded, set the brightness level corresponding to each of the plurality of areas of the display such that a brightness level of a first area among the plurality of areas is different from a brightness level of a second area among the plurality of areas different from the first area, and
wherein the first area is an area to which an amount of incident light exceeds a set threshold illuminance.

12. A method of operating an electronic device, the method comprising:
based on a brightness level of a display of the electronic device being set to be a first level based on an ambient light level, based on a temperature of the electronic device identified using at least one sensor of the electronic device reaching a first temperature, identifying a temperature change rate within a designated time period and determining an intermediate temperature between the first temperature and a second temperature higher than the first temperature, for reducing a brightness level of the display to an intermediate brightness level between the first level and a second level less than the first level, wherein based on the temperature change rate being greater than a threshold temperature change rate, the intermediate temperature is set to a first value, and based on the temperature change rate being less than the threshold temperature change rate, the intermediate temperature is set to a second value greater than the first value, based on the identified temperature change rate;
based on a current temperature of the electronic device reaching the intermediate temperature, reducing the brightness level of the display to the intermediate brightness level; and
based on the current temperature reaching the second temperature, reducing the brightness level of the display to the second level.

13. The method of claim 12, wherein the identifying of, based on the temperature of the electronic device identified using the at least one sensor of the electronic device reaching the first temperature, the temperature change rate within the designated time period and determining of, based on the identified temperature change rate, the intermediate temperature, between the first temperature and the second temperature higher than the first temperature, for reducing brightness level of the display to the intermediate brightness level between the first level and the second level less than the first level comprises reducing, based on the temperature reaching the first temperature, the brightness level of the display according to the plurality of time periods such that the brightness level of the display is controlled to be identical during one or more adjacent time points among the plurality of time periods.

14. The method of claim 12, wherein the at least one sensor comprises at least one thermistor, and
wherein the display includes an active-matrix organic light emitting diode (AMOLED) display.

15. The method of claim 12, further comprising identifying, based on a brightness obtained through an illuminance sensor of the electronic device configured to measure an amount of light incident on the electronic device, whether a condition for operating in a high brightness mode is satisfied,
wherein the controlling of the brightness level of the display of the electronic device to be the first level comprises controlling, based on identifying the condition for operating in the high-brightness mode being satisfied, the brightness level of the display to be the first level, and
wherein the identifying of, based on the temperature of the electronic device identified using the at least one sensor of the electronic device reaching the first temperature, the temperature change rate within the designated time period and determining of, based on the identified temperature change rate, the intermediate temperature, between the first temperature and the second temperature higher than the first temperature, for reducing brightness level of the display to the intermediate brightness level between the first level and the second level less than the first level comprises:
while controlling the brightness level of the display to be the first level, identifying, based on the temperature obtained using the at least one sensor, a current surface temperature of the display; and
determining, based on the current surface temperature reaching the first temperature and the temperature change rate exceeding the threshold temperature change rate, the intermediate temperature to be a first value, for reducing the brightness level of the display to the intermediate brightness level.

16. The method of claim 12, wherein the reducing of, based on the temperature of the electronic device reaching the intermediate temperature, the brightness level of the display to the intermediate brightness level comprises:
reducing, based on the current surface temperature reaching the first temperature and the temperature change rate exceeding the threshold temperature change rate, the brightness level of the display to a first intermediate brightness level set for securing visibility of the display in the high brightness mode; and
reducing, based on the current surface temperature reaching a third temperature higher than the first temperature, the brightness level of the display to a second intermediate brightness level lower than the first intermediate brightness level.

17. The method of claim 12, further comprising:
identifying, based on a time period set for identifying the temperature change rate periodically, whether the temperature and the temperature change rate satisfy a condition for reducing the brightness level of the display;
reducing, based on identifying the temperature and the temperature change rate satisfying the condition, the brightness level of the display; and
maintaining, based on identifying the temperature and the temperature change rate not satisfying the condition, the brightness level of the display.

18. The method of claim 12, further comprising:
identifying, based on a sensing value obtained through a grip sensor of the electronic device, information associated with a grip event of the electronic device; and
determining, based on the identified temperature change rate and the information associated with the grip event, the intermediate temperature,
wherein based on the temperature change rate being greater than a threshold temperature change rate and the grip event not occurring, the intermediate temperature is set to a third value greater than the first value.

19. The method of claim 12, further comprising:
identifying information associated with an application currently being executed; and
determining, based on the information associated with the application currently being executed and the identified temperature change rate, the intermediate temperature,
wherein based on the temperature change rate being greater than a threshold temperature change rate and the application currently being executed being a specified application, the intermediate temperature is set to a third value greater than the first value.

20. A non-transitory computer-readable storage medium storing computer-executable instructions, wherein the computer-executable instructions, when executed by at least one processor including processing circuitry individually or collectively, cause an electronic device to:
based on a brightness level of a display of the electronic device being set to be a first level based on an ambient light level:
based on a temperature of the electronic device identified using at least one sensor reaching a first temperature, identify a temperature change rate within a designated time period and determine the intermediate temperature, between the first temperature and a second temperature higher than the first temperature, for reducing brightness level of the display to the intermediate brightness level between the first level and a second level less than the first level, based on the identified temperature change rate, wherein based on the temperature change rate being greater than a threshold temperature change rate, the intermediate temperature is set to a first value and based on the temperature change rate being less than the threshold temperature change rate, the intermediate temperature is set to a second value greater than the first value;
based on a current temperature of the electronic device reaching the intermediate temperature, reduce the brightness level of the display to the intermediate brightness level; and
based on the current temperature reaching the second temperature, reduce the brightness level of the display to the second level.
